(19) United States
(12) Patent Application Publication
(10) Pub. No.: US 2015/0244656 A1
(43) Pub. Date: Aug. 27, 2015

(54) METHOD AND SYSTEM FOR PROVIDING USER INTERFACE FOR INTERACTIVE BROADCAST PROGRAM USING MOBILE INSTANT MESSENGER

(71) Applicant: Korea Advanced Institute of Science and Technology, Daejeon (KR)

(72) Inventors: Jun Kyun Choi, Daejeon (KR); Jin Hong Yang, Daejeon (KR); Na Gyeong An, Daejeon (KR); Hyo Jin Park, Daejeon (KR); Hyo Ju Park, Daejeon (KR)

(73) Assignee: Korea Advanced Institute of Science and Technology, Daejeon (KR)

(21) Appl. No.: 14/421,433

(22) PCT Filed: Dec. 6, 2012
(86) PCT No.: PCT/KR2012/010537

§ 371 Date: Feb. 12, 2015

(30) Foreign Application Priority Data
Aug. 13, 2012 (KR) 10-2012-0088131
Aug. 13, 2012 (KR) 10-2012-0088132
Aug. 16, 2012 (KR) 10-2012-0089373
Sep. 5, 2012 (KR) 10-2012-0098073
Sep. 17, 2012 (KR) 10-2012-0102563

(51) Int. Cl. H04L 12/58; G06F 3/0484

(52) U.S. Cl. CPC H04L 51/046; H04L 51/32; G06F 3/04842

(57) ABSTRACT

Disclosed are a method and system for providing a user interface for an interactive broadcast program using a mobile instant messenger. The method for providing a user interface for an interactive broadcast program comprises the steps of: executing a chat room capable of participating in a broadcast program using a program ID, which is a buddy ID generated on a mobile instant messenger (IM), for the broadcast program; and displaying messages with regard to the broadcast program sent to or received from a user via the chat room. The step of displaying messages may provide a plurality of input buttons as a user interface (UI) for inputting messages from the user on the screen of the chat room, the input buttons enabling messages to be inputted for each participation objective in the broadcast program.

### TECHNICAL FIELD

Embodiments of the present invention relate to a method and system for providing a user interface suitable for various demands of an interactive broadcast program using a mobile instant messenger (IM).

### RELATED ART

Not to mention of the recent fusion between broadcasting and communication, the distributions of various terminals, such as a smart television (TV), a smartphone, and an Internet protocol (IP) TV, have brought a transition from an existing uni-directional TV environment to a bi-directional participative environment capable of interacting with users.

To trigger a user participation, an interactive broadcast service producing method according to a related art has adapted a separate individual exclusive mobile application or a short message service mobile oriented (SMS-MO) system to fit for a broadcasting environment. However, in the case of using the exclusive application, a corresponding application is to be installed for the user participation. In the case of using the SMS-MO system, a user needs to pay a communication company for separate communication expenses. Also, due to the diversification of channels allowing users to participate in a broadcast program, the existing method has some constraints in terms of expandability and instantaneity in the case of using various channels to optimize the user participation for each individual program.

Further, in the case of a program produced in series, program copyright information of each episode is managed and used in an individual document form. That is, since writers or producers (PDs) are managing information of each episode in an individual document form, the management efficiency may be degraded. In addition, issues such as duplicity or loss of a document are highly likely to arise and formatting information for each episode may be inconvenient.

In particular, when a user is to participate in a broadcast program using a mobile instant messenger (IM) service, there are some constraints in sending a message for participation in the broadcast program since an existing messenger provides only a single button (for example, a “send” button) as a user interface for inputting a message. To recognize the message for participation in the broadcast program, a hash tag needs to be used or a character string suitable for a format designated in a system needs to be accurately input. Only in this case, the message may be acknowledged as a valid message. In the existing messenger, responses to various demands of the broadcast program and general chats are sent without being identified in a chatting room that participates in the broadcast program. That is, in the chatting room, it is difficult to identify a message input from a user, such as a response to a vote, an answer to a quiz, and a general message. The system may need to filter all the messages to identify such messages, thereby causing overhead. Accordingly, the overhead may degrade the efficiency and real-time aspects.

### DETAILED DESCRIPTION

### Technical Object

An aspect of the present invention provides a program enabler service method and system that may format information for each episode by providing an authoring tool required to produce a user participative interactive broadcast program.

An aspect of the present invention also provides a program enabler service method and system that may support an environment capable of directly executing an interactive broadcast program produced using an editor for producing the interactive broadcast program through association between the editor and various services.

An aspect of the present invention also provides a program enabler service method and system that may provide hint information by identifying users that match a predetermined condition with respect to a question given in an interactive program.

An aspect of the present invention also provides a program enabler service method and system that may provide an interactive service by employing an existing mobile instant messenger (IM) service as a user participation means to a program.

An aspect of the present invention also provides a program enabler service method and system that may provide an interactive broadcast program allowing a user participation using a buddy setting of a mobile IM.

An aspect of the present invention also provides a program enabler service method and system that may concurrently provide a broadcast participating function and a buddy chatting function through a group chatting room of a mobile IM to enable the seamless progress of a participation in a broadcast and conversation with buddies.

An aspect of the present invention also provides a program enabler service method and system that may provide a user interface suitable for various demands of an interactive broadcast program when participating in a broadcast using a mobile IM.

An aspect of the present invention also provides a program enabler service method and system that may provide a color index based on an air time of a broadcast program or an event within the broadcast program when performing an interactive broadcast program through a user participation using a mobile IM.

An aspect of the present invention also provides a program enabler service method and system that may provide time information based on a program progress time when performing an interactive broadcast program through a user participation using a mobile IM.

An aspect of the present invention also provides a program enabler service method and system that may set a response order between participants included in a group in the case of a group unit participation for further aggressive and interactive participation in a broadcast program.

### Solutions

According to an embodiment of the present invention, a method of providing a user interface for an interactive broadcast program may include: executing a chatting room that allows a participation in a broadcast program using a program identifier (ID) that is a buddy ID created on a mobile instant messenger (IM) with respect to the broadcast program; and displaying a message sent to or received from a user in association with the broadcast program through the chatting room. In this instance, the displaying of the message may include providing a plurality of input buttons of identifying an intent for participation in the broadcast program and thereby enabling a message input, as a user interface for inputting a message of the user, on a screen of the chatting room.

According to an aspect, a color index according to a type of the message may be applied on the screen of the chatting room.

According to another aspect, the displaying of the message may include providing the user with time information associated with an interactive object based on a progress time of the broadcast program on the screen of the chatting room, with respect to the interactive object that allows a participation of the user in the broadcast program.

According to still another aspect, the executing of the chatting room may include executing a group chatting room that allows a participation of a group unit with respect to the broadcast program; and setting a response order of the user in the group chatting room with respect to an interactive object that allows a participation of the user in the broadcast program.

According to an embodiment of the present invention, a system for providing a user interface for an interactive broadcast program, the system including: a processor; and a computer storage medium configured to store a mobile IM application executed by the processor. The mobile IM application may include a UI management module configured to execute a chatting room that allows a participation in a broadcast program using a program ID that is a buddy ID created on a mobile IM with respect to the broadcast program, to display a message sent to or received from a user in association with the broadcast program through the chatting room, and to provide a plurality of input buttons of identifying an intent for participation in the broadcast program and thereby enabling a message input, as a user interface for inputting a message of the user, on a screen of the chatting room.

According to an aspect, the UI management module may be configured to display the message on the screen of the chatting room using a color designated based on a color index that identifies a type of the message using a different color.

According to another aspect, the UI management module may be configured to display at least one of statistical information and time information associated with an interactive object based on a progress time of the broadcast program, with respect to the interactive object that allows a participation of the user in the broadcast program.

According to still another aspect, the UI management module may be configured to set a response order of the user in the group chatting room with respect to an interactive object that allows a participation of the user in the broadcast program.

### Effects of the Invention

According to embodiments of the present invention, there is provided a system in which an editor for producing an interactive broadcast program and an enabler capable of associating and thereby executing a broadcast program produced through the editor with existing communication channels are combined and thus, it is possible to format program information and thereby improve the production and management efficiency. Also, it is possible to easily and conveniently provide various communication functions required for the interactive broadcast program.

According to embodiments of the present invention, there is provided the overall monitoring function for an interactive broadcast service in a studio environment using a program enabler service system for producing and executing a program. Thus, during a program progress, a producer, in person, may verify a real-time status such as user participation information easily and conveniently in the studio environment.

According to embodiments of the present invention, a hint is provided by identifying users matching a predetermined condition with respect to a question given in an interactive program. Thus, when providing hint information through a broadcast, it is possible to prevent hint information from being exposed to all the users. Also, when giving a hint using an individual user channel, it is possible to trigger a user participation using forms applied to various business models.

According to embodiments of the present invention, by employing an existing mobile instant messenger (IM) service as a user participation means to a program, a user may participate in a program using only an existing mobile IM without a need to install a separate exclusive application. Accordingly, from perspective of a program producer, it is possible to save costs that may occur by developing and distributing, and maintaining and repairing an additional mobile application, and to easily secure existing messenger users. Further, from perspective of a mobile IM provider, it is possible to make service revenues by developing a function exclusive for an interactive program and by providing a related additional service.

According to embodiments of the present invention, a broadcast participation function and a buddy chatting function are concurrently provided to a user through a group chatting function on a mobile IM and thus, it is possible to easily meet the needs of the user without a transition between applications or between screens.

According to embodiments of the present invention, a mobile IM may provide an interface environment suitable for various intents for participation in an interactive broadcast program and thus, it is easy to send a message of a user based on a participation intent and also effective to filter a message when a system receives the message.

According to embodiments of the present invention, a color index based on an air time of a broadcast program or an event within the broadcast program is provided when performing an interactive broadcast program through a user participation using a mobile IM and thus, it is possible to easily identify a message through the color index and to improve a user convenience for a broadcast participation.

According to embodiments of the present invention, a remaining time in which a user participation is allowed is provided on a user interface of a messenger based on a progress time of a broadcast program when a user participates in the broadcast program through a message using a mobile IM and thus, it is possible to improve a user convenience for a broadcast participation.

According to embodiments of the present invention, a function for setting a response order between participants is provided in the case of a group unit participation using a mobile IM and thus, it is possible to trigger a further aggressive group participation in a broadcast program and to further diversify an interactive service characteristic.

### BRIEF DESCRIPTION OF DRAWINGS

FIG. 1 is a block diagram illustrating a configuration of a program enabler service system according to an embodiment of the present invention.

FIG. 2 is a block illustrating a configuration of a program enabler service system for producing and executing a user participating broadcast program according to an embodiment of the present invention.

FIGS. 3 through 13 illustrate examples of an editor screen for producing a broadcast program according to an embodiment of the present invention.

FIGS. 14 through 17 illustrate examples of a monitoring screen for an interactive service of a broadcast program according to an embodiment of the present invention.

FIG. 18 is a block diagram illustrating a configuration of a program enabler service system in which a mobile instant messenger (IM) enabler is included as an interactive service enabler according to an embodiment of the present invention.

FIGS. 19A through 20B are flowcharts illustrating a process of creating a program chatting room for a user participation on a mobile IM according to an embodiment of the present invention.

FIGS. 21A through 21C are flowcharts illustrating a process of providing a question and a hint of the question through a mobile IM during a program progress according to an embodiment of the present invention.

FIGS. 22A through 22C are flowcharts illustrating a process of providing an interactive question through a mobile IM during a program progress according to an embodiment of the present invention.

FIG. 23 is a flowchart illustrating a method of producing an interactive broadcast program by a producer in a program enabler service method according to an embodiment of the present invention.

FIG. 24 is a flowchart illustrating a method of creating a program identifier (ID) by a program manager in a program enabler service method according to an embodiment of the present invention.

FIG. 25 is a flowchart illustrating a method of executing a broadcast program in interaction with an interactive service enabler in a program enabler service method according to an embodiment of the present invention.

FIGS. 26 and 27 illustrate examples to describe a method of registering a user as a participant in a program chatting room according to an embodiment of the present invention.

FIGS. 28 and 29 illustrate examples of a user interface (UI) for identifying and thereby inputting a response to a question and a response to a hint query in a program chatting room according to an embodiment of the present invention.

FIG. 30 is a flowchart illustrating a method in which a user participates in a program through a mobile IM on a terminal of the user in a program enabler service method according to an embodiment of the present invention.

FIG. 31 is a flowchart illustrating a method of providing a color index function for identifying a message in a program chatting room in a program enabler service method according to an embodiment of the present invention.

FIG. 32 illustrates an example of a UI to describe a color index for each message in a program chatting room according to an embodiment of the present invention.

FIGS. 33 through 37 illustrate examples of a UI for providing time information associated with a broadcast program on a screen of a program chatting room according to an embodiment of the present invention.

FIGS. 38 through 39 illustrate examples to describe a method of registering users as participants in group chatting of a program chatting room according to an embodiment of the present invention.

FIGS. 40 through 42 illustrate examples to describe a method of determining response orders of users with respect to a broadcast program according to an embodiment of the present invention.

FIG. 43 is a flowchart illustrating a method in which a user participates in a program through a mobile IM using a terminal of the user, in a program enabler service method according to an embodiment of the present invention.

FIG. 44 illustrates an example of a UI for inputting a message in a group chatting room according to an embodiment of the present invention.

FIG. 45 illustrates an example to describe a method of processing a response to a question based on a participation order designated in a program chatting room according to an embodiment of the present invention.

FIGS. 46 and 47 illustrate examples of a UI for protecting a message responding to a broadcast program in a group chatting room according to an embodiment of the present invention.

### BEST MODE

Hereinafter, embodiments of the present invention will be described.

An interactive broadcast service has been evolved to a level at which a participation and a response through direct interaction with individual programs are allowed, beyond a service level for simply verifying information associated with a program or news. During such a process, various types of broadcasting genres will be developed. In particular, a reference program that draws a high participation of users is to be distributed in an individual program format and grown into the global format business.

Accordingly, the present invention proposes a technology capable of providing various communication functions required for an interactive broadcast service, together with a production tool directly executable in a real broadcasting environment in order to achieve a user participative interactive broadcast service.

In the present specification, the term “broadcast program” may inclusively indicate multimedia contents produced to enable any type of interactivities, for example, a user participation such as a question (quiz), a survey, a vote, and an application, and a user record such as a bookmark and an annotation. The term “producer” may indicate a target that plans and produces an interactive broadcast program, such as a writer or a PD in broadcasting. The term “manager” may indicate a target that is in charge of a system setting and operation to provide an interactive broadcast program. Also, the term “user” or “participant” may indicate a target that directly participates in a broadcast program as a viewer viewing the broadcast program.

Embodiments of the present invention may be applied to all the systems based on a user participative interactive service, such as an e-Learning system, not to mention of a broadcast system of a TV environment.

Hereinafter, a program enabler service system and a program enabler service method for providing an interactive service of a broadcast program will be described based on an example of a broadcast program in which a question is given during a broadcast and a user participates.

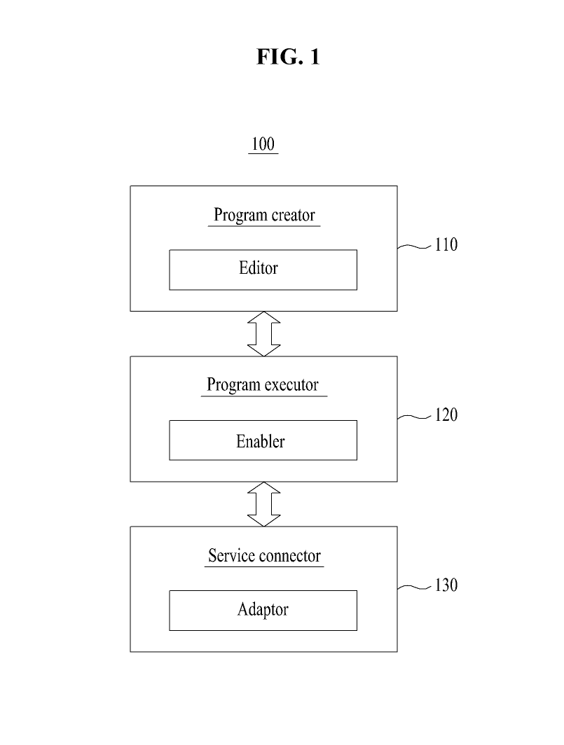

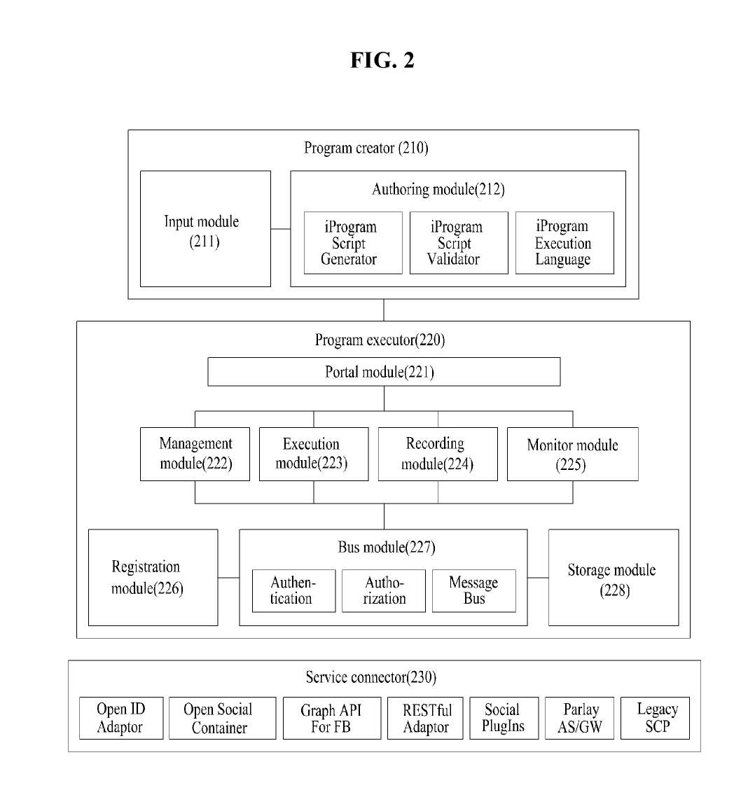

FIG. 1 is a block diagram illustrating a configuration of a program enabler service system according to an embodiment of the present invention.

Referring to FIG. 1, the program enabler service system may include a program creator 110 for creating a broadcast program, a program executor 120 for executing the broadcast program created by the program creator 110, and a service connector 130 for connecting a communication service for interacting with the broadcast program executed by the program executor 120.

As a system available by a producer at the planning stage to produce a broadcast program, the program creator 110 may support a tool (iFormat editor) of providing a production function of designing and scripting parts allowing a user participation in the broadcast program using a predefined enabler and a visual tool, and directly executing the scripted parts in a real broadcasting environment. In the present embodiment, as a program authoring tool required at the stage of producing the broadcast program, a function capable of inputting basic information required for the broadcast program, a function capable of selecting a broadcast participation channel by adding various service enablers, and a function capable of easily editing information for each episode of the broadcast program, converting the information to a script format, and launching the converted information in a real broadcasting environment may be provided.

As an enabler system for executing the broadcast program, the program executor 120 may read broadcast program information produced using the tool, may provide an interactive participation means required for the corresponding broadcast program in association with various communication channels such as various legacy systems and/or social services, may provide statistical information of the corresponding broadcast program, and may support a function such as a monitoring tool and a user response management for progress of the broadcast program.

The service connector 130 may support an adaptor function capable of easily and conveniently associating various communication channels with the broadcast program. In the present embodiment, various communication functions required to service a broadcast program may be provided as a technology for easy and convenient interaction between various communication channels and the broadcast program.

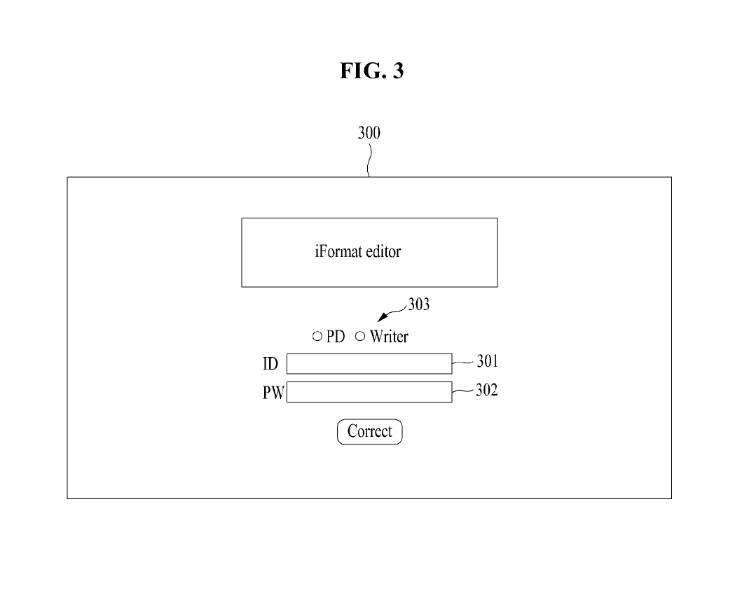

Hereinafter, a program creator 210, a program executor 220, and a service connector 230 will be described with reference to FIG. 2.

The program creator 210 is configured to provide an environment (iProgram Creation Environment) for authoring a broadcast program and may include an input module (iFormat Editor) 211 and an authoring module (iProgram Designer) 212.

The input module 221, as a tool used by a writer or a PD in broadcasting to plan an interactive program, may indicate a tool for registering/correcting/deleting a program information input and participation method, a question, and the like.

The authoring module 212 may author the broadcast program in a format executable in the program executor 220 by scripting data input to the input module 211 through various types of modules (iProgram Script creator, iProgram Script Validator, iProgram Execution Language) for scripting the broadcast program.

FIGS. 3 through 13 illustrate editor screens provided from the input module 211.

Referring to FIG. 3, the input module 211 may provide a log-in screen 300 for allowing an access of a producer having a right to input and correct information of a broadcast program. In this instance, the log-in screen 300 is configured to receive an identifier (ID) 301 and a password (PW) 302. When an editor right is different for each type of producer such as a PD and a writer in broadcasting, the log-in screen 300 may receive an ID/PW together with a producer type 303.

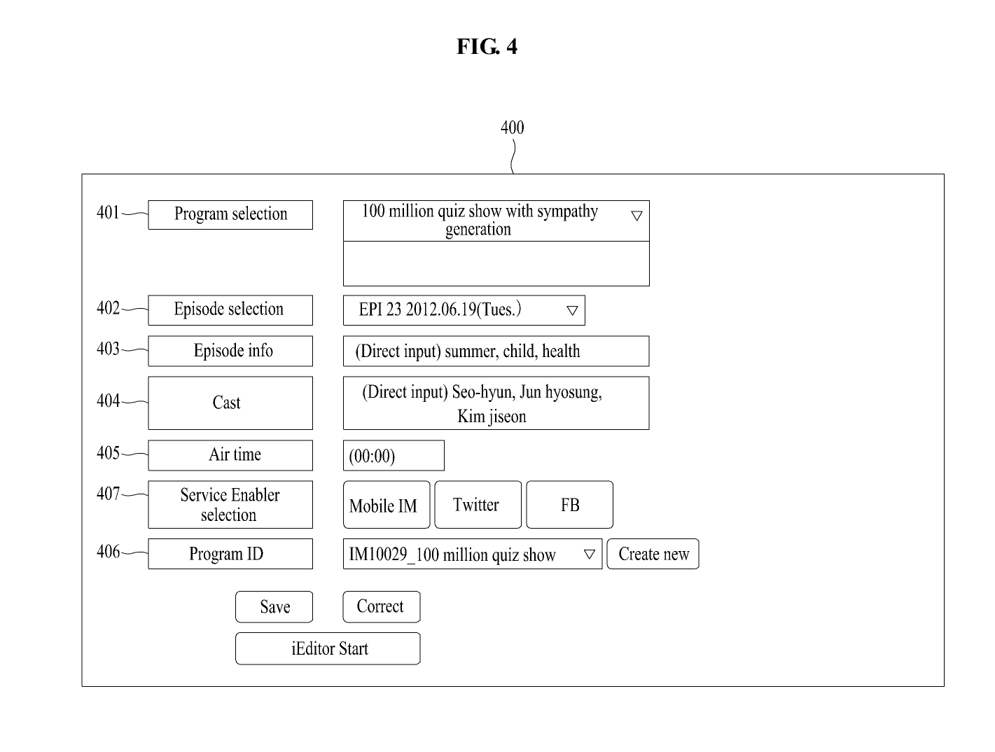

Referring to FIG. 4, the input module 211 may provide an editor start screen 400 to a producer connected through a log-in procedure. The producer may select or input a program 401 and an episode 402 that are to be authored through the editor start screen 400. In addition, the producer may input episode information (comment) 403, cast information 404, an air time 405, and a program ID 406. Further, for communication with a user, a service enabler 407, such as a mobile instant messenger (IM), Twitter, and Facebook, which is to interact with the broadcast program, may be selected on the editor start screen 400. Here, the program ID 406 is an ID of a program manager. For example, when a mobile IM is used as a communication channel with a user, the program manager needs to be regarded as a single buddy ID. A buddy ID for a corresponding program needs to be created for a question and an answer through the mobile IM. The editor start screen 400 may be configured using a direct input method of a producer and a selection method from a predetermined item.

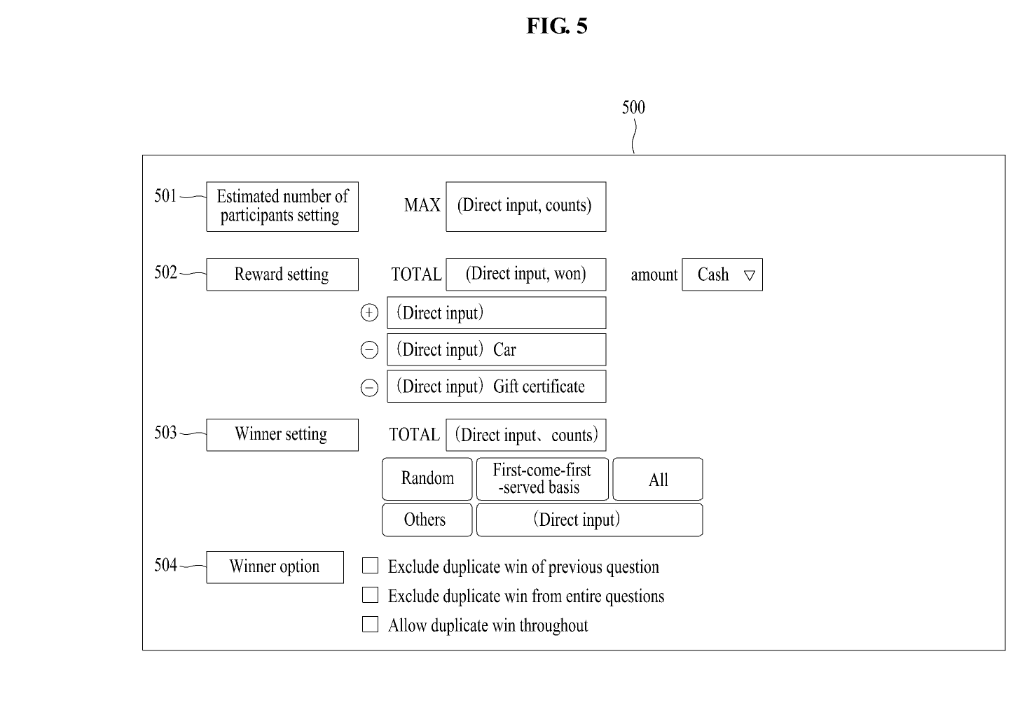

Referring to FIG. 5, the input module 211 may provide an initial setting screen 500 for inputting basic information required for the broadcast program. The estimated number of participants 501 in the broadcast program, a reward (for example, money and gifts) 502, a winner (the number of persons or conditions) 503, and other options associated with a winner 504 may be set on the initial setting screen 500. The initial setting screen 500 may be configured using a direct input method of a producer and a selection method from a predetermined item.

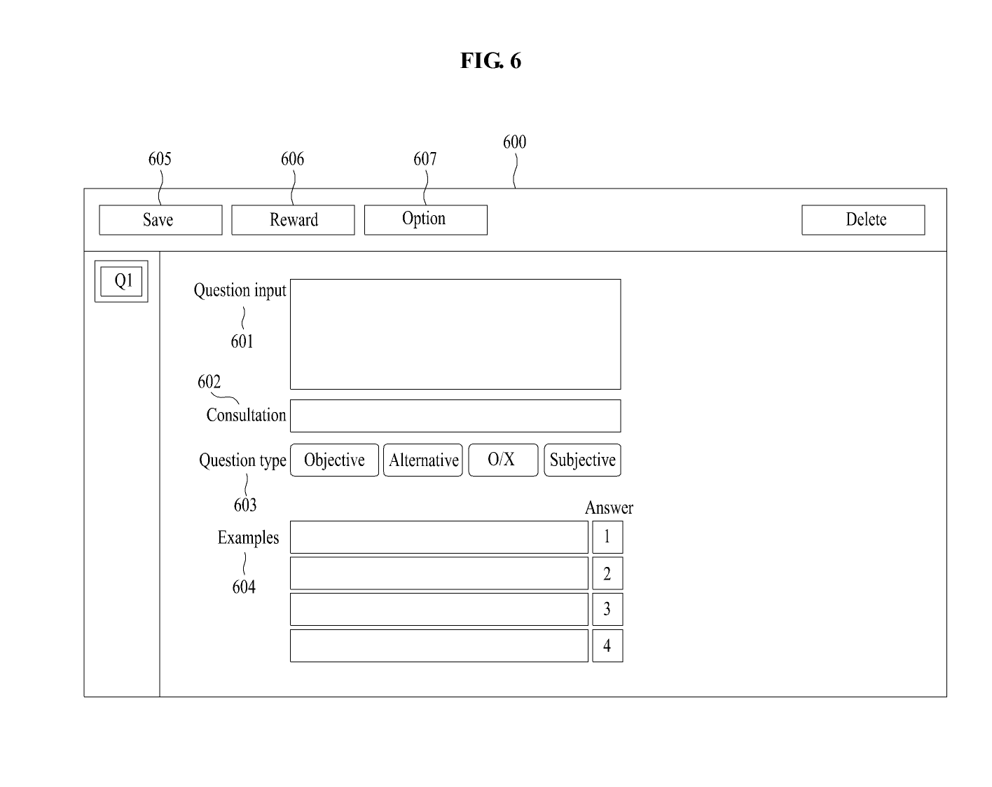

Referring to FIG. 6, the input module 211 may provide a question screen 600 for inputting a question during a broadcast. Here, the question screen 600 may include contents 601 of a question, a consultation 602 associated with the question, a type 603 of the question, and examples 604 of a multiple-choice question. Also, the question screen 600 may include a “save” menu 605 for storing a question input by a producer, a “reward” menu 606 for setting a reward for the question, and an “option” menu 607 for setting an option associated with the question.

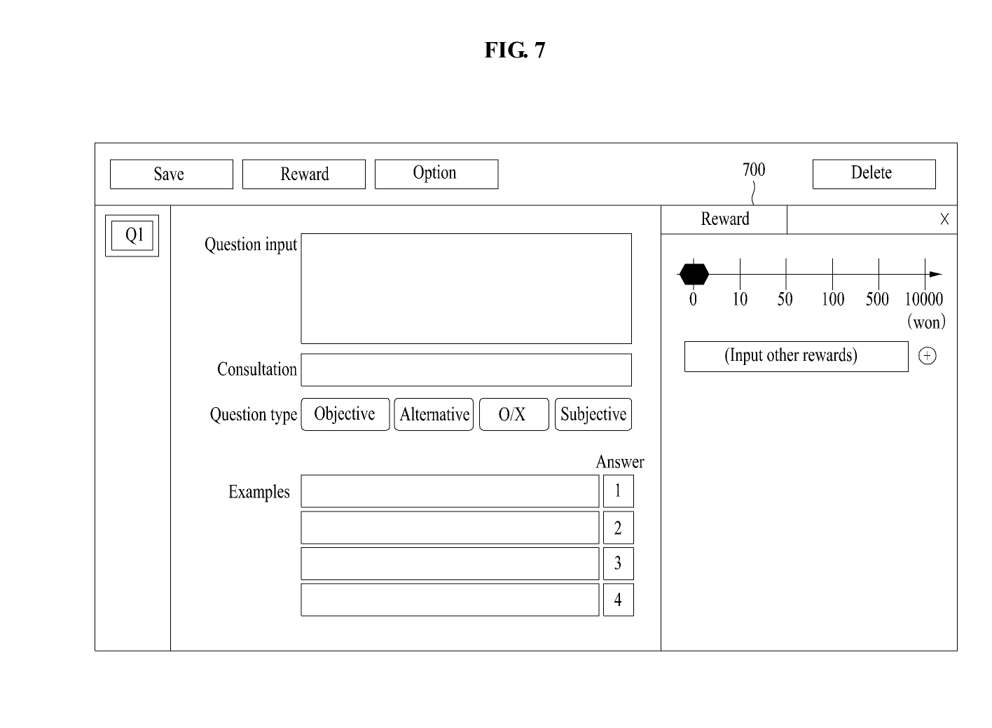

FIG. 7 illustrates a reward setting screen 700 displayed in response to the “reward” menu 606 on the question screen 600. A producer may set a reward to be provided to a correct answerer through the reward setting screen 700. In this instance, the reward may be individually set for each question.

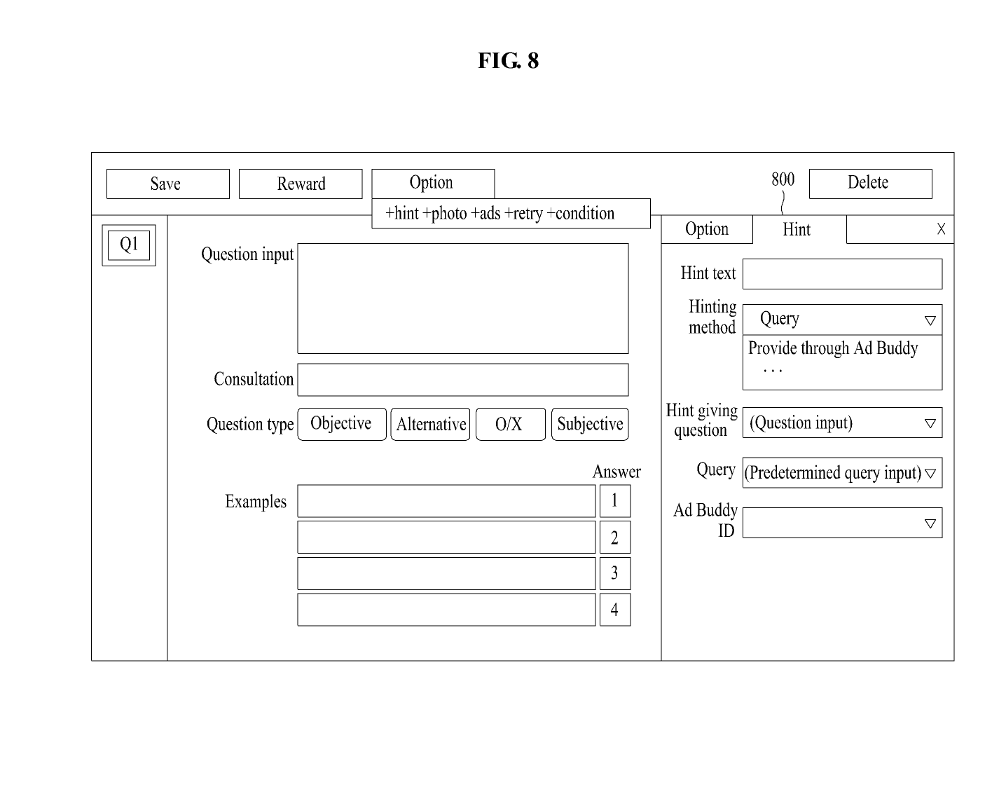

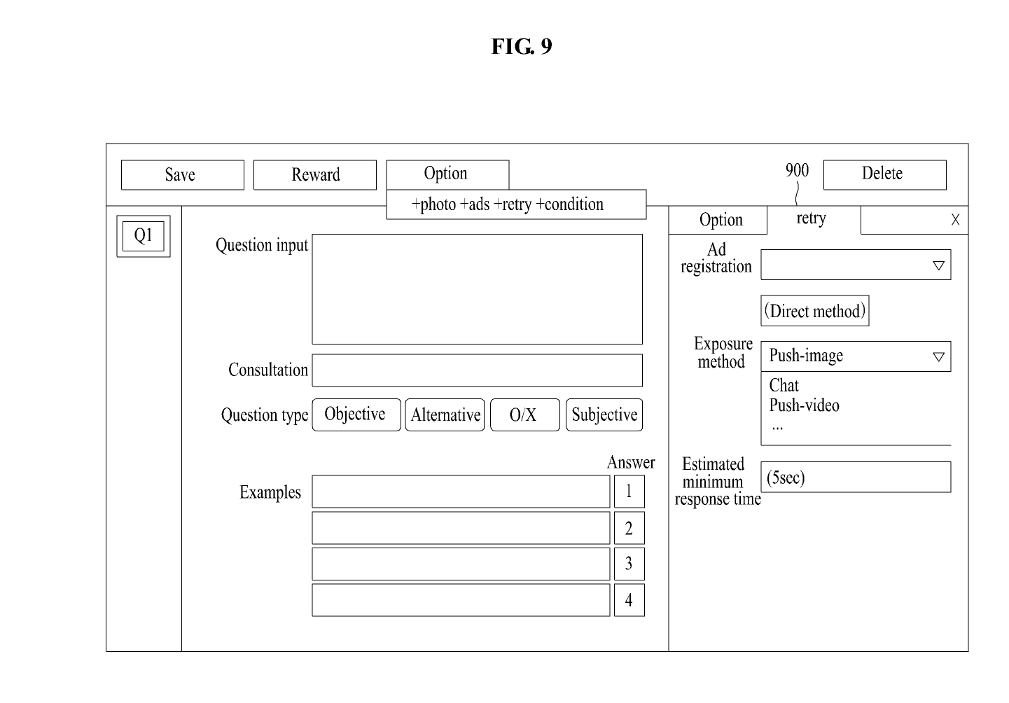

FIG. 8 illustrates an option setting screen 800 displayed in response to the “option” menu 607. A producer may individually register various options, such as a photo (still image, a video, etc.), advertisements (ads), and a condition in association with each question, through the option setting screen 800. Also, the option setting screen 800 may provide a function of giving a hint to participants matching a predetermined condition and a function of setting whether a retry opportunity is available, as an individual question option. Referring to FIG. 8, the producer may set a hint to be given to participants by setting a hint text, a target to receive a hint, a hinting method, and a hint query. A method of selecting a target to receive a hint may use a method designated by a program producer among a variety of methods such as a method of responding to a predetermined query, a method of responding to a predetermined advertisement, a method of responding to predetermined content (video or a voice file), a method using a location matching condition (for example, a user located at a predetermined location and a user having checked in at a predetermined location). Also, when the target to receive a hint is determined, a method of giving a hint may use a method of giving a hint to the corresponding target in an attached file format or a message format through a mobile IM. Referring to FIG. 9, the producer may set a retry opportunity to be assigned to a participant having made an answer corresponding to a predetermined condition by setting a means (for example, an advertisement) for assigning a retry opportunity, a method of displaying the means, and a response time to the means.

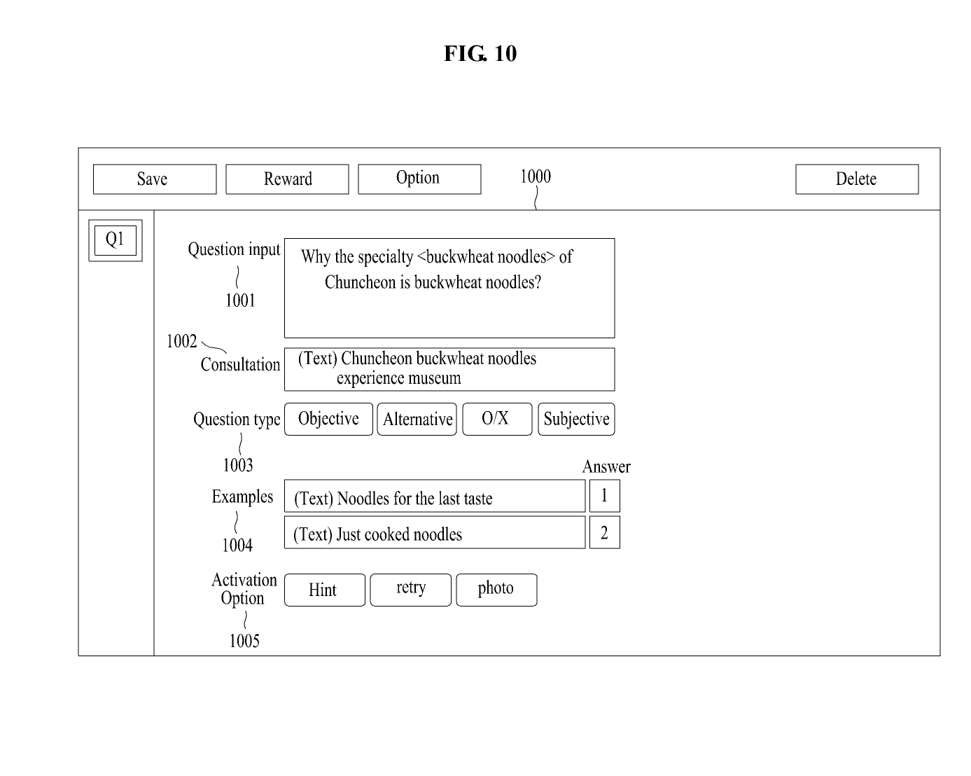

FIG. 10 illustrates an example of a question screen 1000 input by a producer. Referring to FIG. 10, “why the specialty <buckwheat noodles> of Chuncheon is buckwheat noodles” in contents of a question 1001, “Chuncheon buckwheat noodles experience museum” as a consultation 1002 thereto, an “alternative” type as a question type 1003, and two examples as examples of the alternative 1004 may be displayed on the question screen 100 based on an input and settings of the producer. In addition, an option status 1005 of a question set by the producer may also be displayed on the question screen 1000 based on a setting of the producer.

Questions to be given in a broadcast program through editor screens described with reference to FIGS. 3 through 10 may be individually created. In this instance, a list of questions created by the producer may be sequentially aligned and thereby displayed on one side of a question screen.

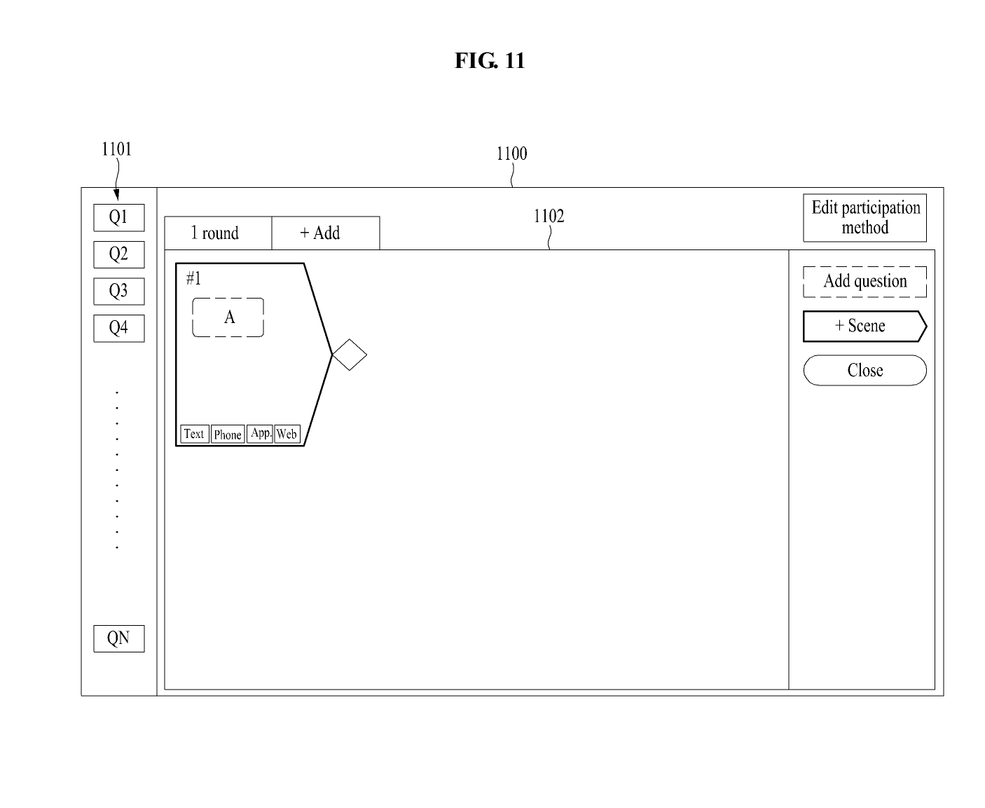

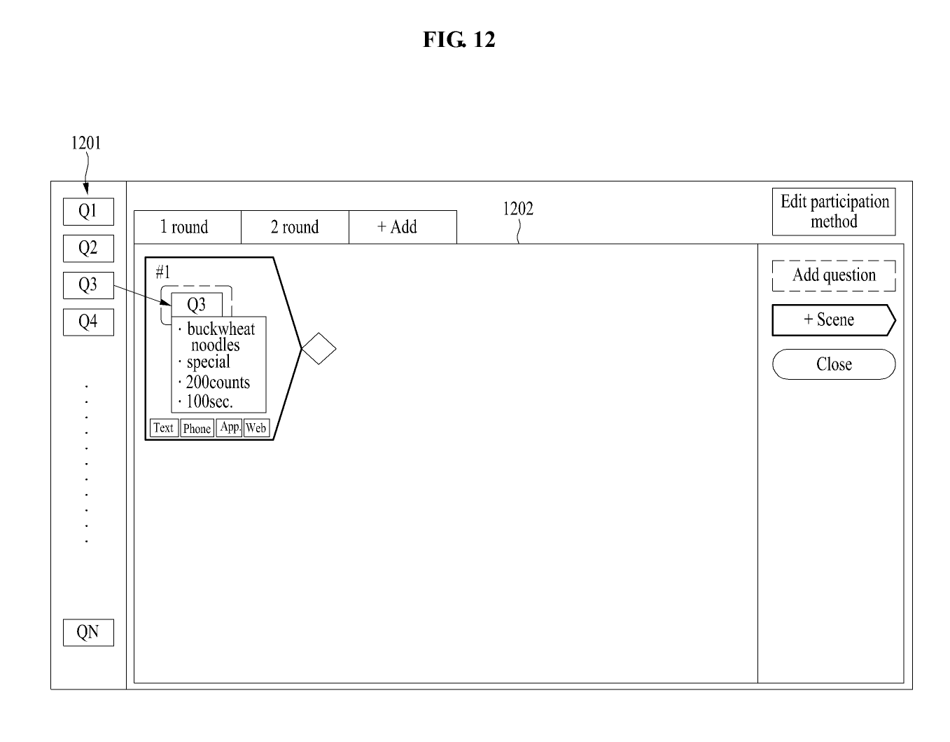

Referring to FIG. 11, when creation and setting of questions to be given for a predetermined episode of a broadcast program are completed, the input module 211 may provide a process creation screen 1100 for setting a question solving process. In this instance, the process creation screen 1100 may also provide a list 1101 of questions created by a producer and a screen 1102 for adding a question to a list for each round. For example, referring to FIG. 12, the producer may selectively set a question to be given for each round by selecting a question to add to each round from a list 1201 of questions and dragging the selected question to a question addition screen 1202.

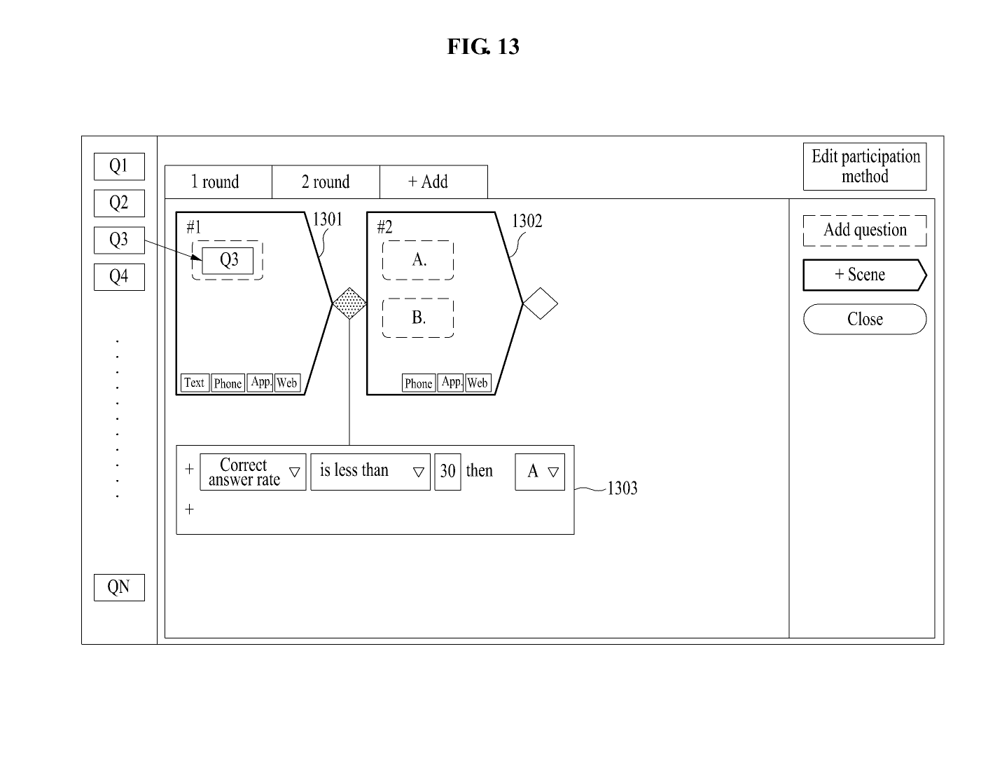

Further, the process creation screen 1100 may provide a function of adding two or more questions as a question to be given at one round and a function of setting detailed conditions for connection between questions. That is, two or more questions of different conditions based on a previously given question may be set as subsequent questions to be given (interactive question). Referring to FIG. 13, in an example in which questions A and B are set as a question 1302 to be subsequently given after a first question 1301 is given at a first round, a condition 1303 may also be set that if a correct answer rate of a first question is 30% or less, the question A is given as a subsequent question, and if the correct answer rate of the first question exceeds 30%, the question B is given as the subsequent question.

According to the above configuration, the input module 211 may provide a function of inputting basic information (episode number, broadcast start/end time) of a broadcast program and a function of selecting a service enabler to interact with the broadcast program through the aforementioned editor screen, and may also provide the overall function of inputting an interactive object (for example, a quiz, a survey, an application, and a vote) allowing a user to participate in the broadcast program and creating a participation process for the corresponding interactive object.

Referring again to FIG. 2, the program executor 220 serves to provide an environment (iProgram Runtime Environment) for executing a broadcast program authored by the producer. Referring to FIG. 2, the program executor 220 may include a portal module (iProgram Studio Portal) 221, a management module (iProgram Lifecycle Manager) 222, an execution engine (iProgram Execution Engine) 223, a recording module (iProgram Logger) 224, a monitor module (iProgram Monitor) 225, a registration module (iProgram UDDI Repository) 226, a bus module (iProgram Bus) 227, and a storage module (iProgram Database) 228.

The portal module 221, as a web-based portal system for using an enabler system, indicates a system accessible by registering a user ID at the event of launching an individual service enabler and basically used by a program manager. The portal module 221, as a service enabler for communication with a user, may interact with a mobile IM, Twitter, and Facebook.

The management module 222 may provide a function of managing a service lifecycle of an individual service enabler and a function of launching and closing a service to fit for a broadcasting environment in interaction with the broadcast program.

The execution engine 223, as an engine for executing an interactive service, may indicate an engine that provides the interactivity of the broadcast program through combination with program information provided in a script format and a service in an enabler type.

The recording module 224 may provide a function of recording various events of an interactive service enabler interacting with the broadcast program.

The monitor module 225 may provide a function of monitoring an operation status of the interactive service enabler interacting with the broadcast program.

The registration module 226 may provide a function of registering and managing information of the interactive service enabler interacting with the broadcast program and service adaptor information of the corresponding enabler.

The bus module 227 may provide a message transfer function (message bus) through the interactive service enabler interacting with the broadcast program and an authentication (authorization) function for a message.

The storage module 228 may provide a function of storing and maintaining the overall information required for an interactive service of the broadcast program.

The service connector 230 may provide an adaptor function for connecting various communication channels for the interactive service of the broadcast program. For example, an open ID adaptor, an open social container, a graph API for facebook, a RESTful adaptor, a social plug-in system (PlugIns), a parlay AS/GW, and a legacy SCP may be applicable to connect a user communication channel.

In the present embodiment constructed as above, it is possible to provide an environment for authoring a broadcast program by formatting program information for each episode and an environment for executing various communication functions and a broadcast program in interaction with an interactive service enabler.

In the present embodiment, it is possible to provide a monitoring function for an interactive broadcast service in a studio environment using the program enabler service system 200 constructed as above. The monitor module 225 may provide a function of verifying spontaneous viewer participation information and a function of providing program progress information of a master of ceremonies (MC) in a live broadcasting environment, in a separate UI form. For example, the monitor module 225 may provide a function of providing current participant information, a participation status for each region, a participation status for each age, a participation status for each sex, participant statistical information for each question, and an individual participant status and a function of supporting a connection (text or a call) with a viewer during a program progress.

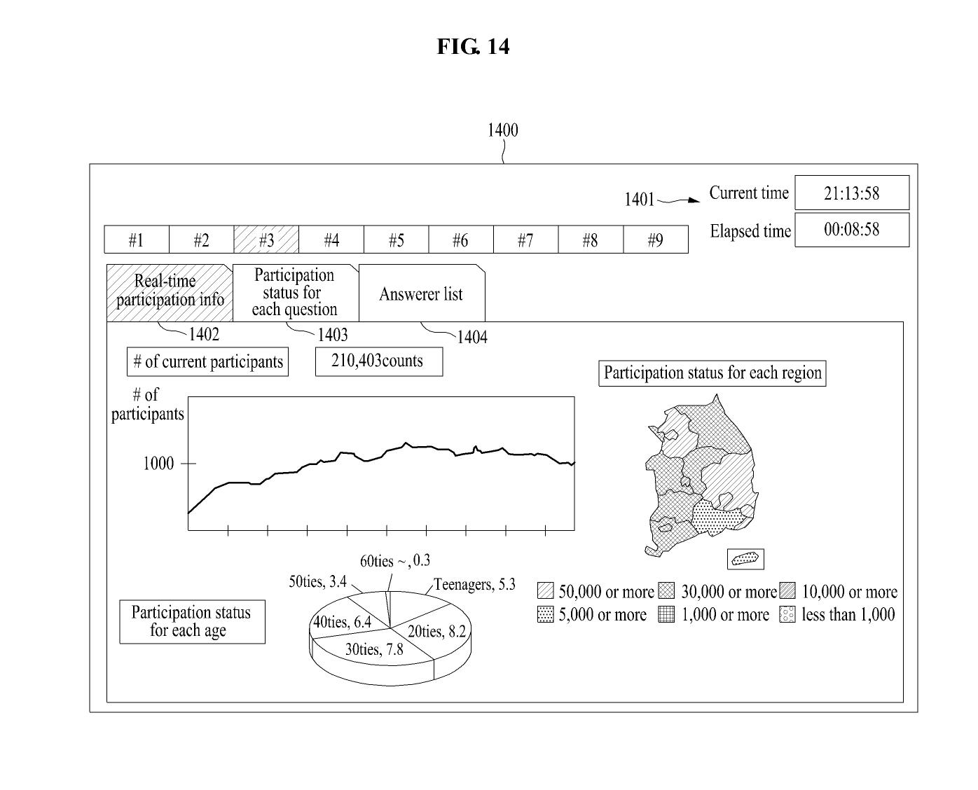

FIGS. 14 through 17 illustrate user interface (UI) screens provided from the monitor module 225.

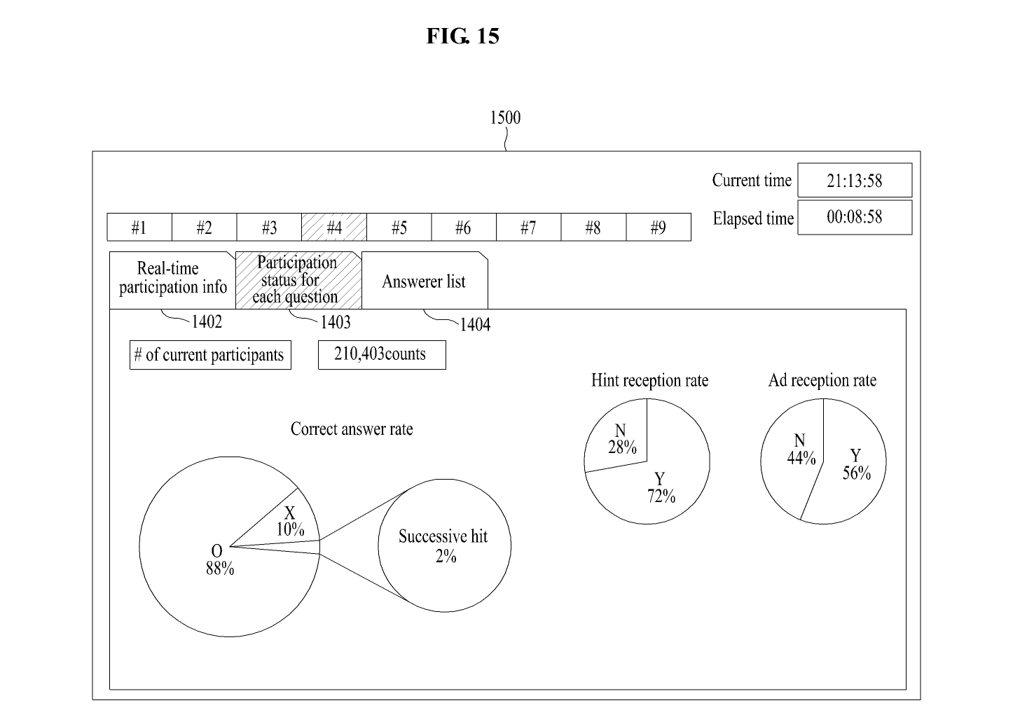

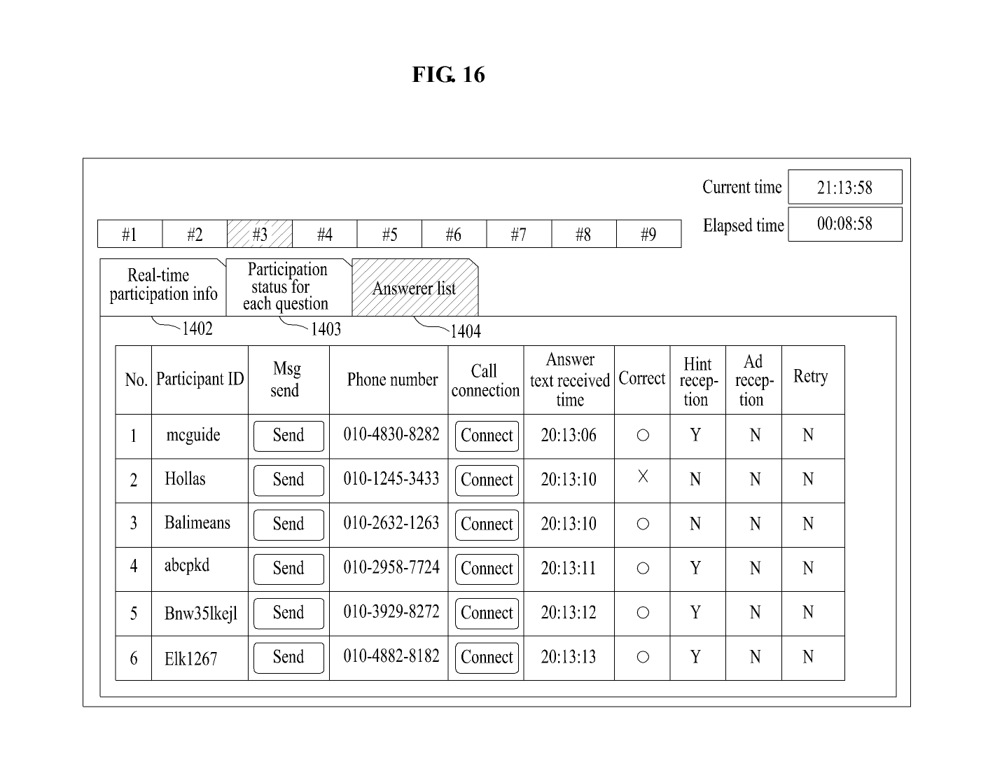

Referring to FIG. 14, the monitor module 225 may provide a manager monitor screen 1400 in response to a request of a producer or a manager. The manager monitor screen 1400 may provide program related time information 1401 (for example, a current time, an elapsed time, etc.), a “real-time participation information” tap 1402, a “participation status for each question” tap 1403, and an “answerer list” tap 1404. Here, referring to FIG. 14, the “real-time participation information” tap 1402 may provide the number of current participants collected in real time, a participation status for each region, a participation status for each age, and a participation status for each sex. Also, referring to FIG. 15, the “participation status for each question” tap 1403 may provide a correct answer rate, a hint reception rate, an ad reception rate, and a retry rate for each question. Referring to FIG. 16, the “answerer list” tap 1404 may provide a participant ID, a phone number, a time at which an answer text is received, whether the answer is correct, whether a hint is received, whether an ad is received, and whether a retry challenge is available, and may also provide a related UI such as a message sending function through a participant ID and a call connecting function through a phone number.

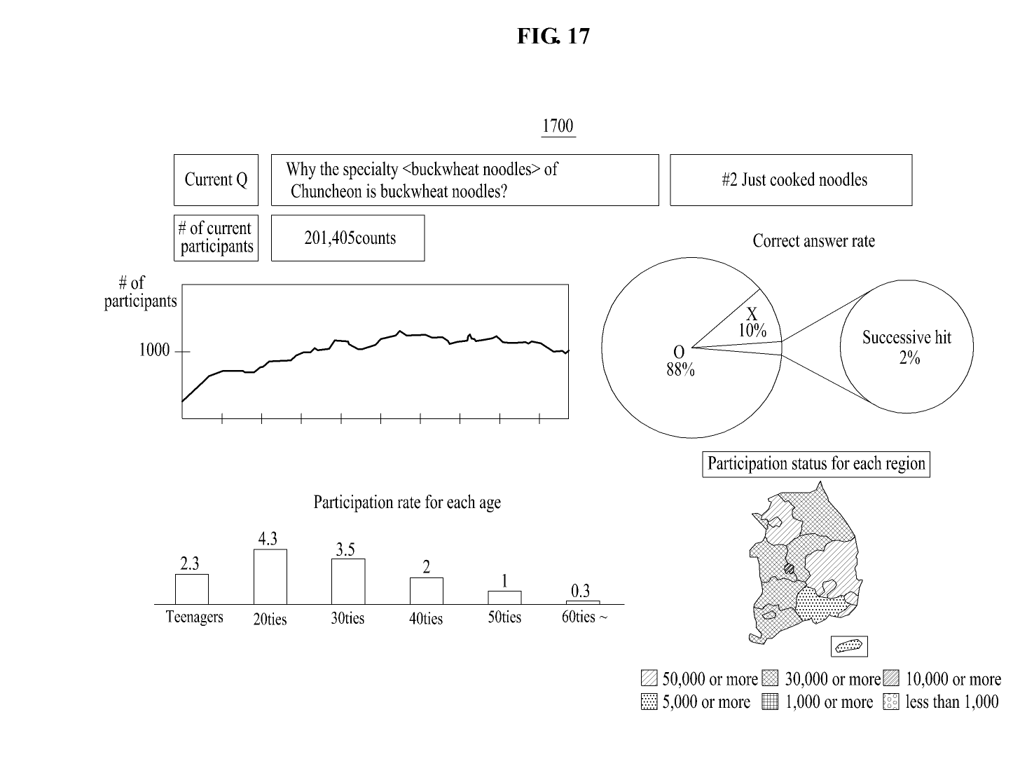

Referring to FIG. 17, the monitor module 225 may provide a host monitor screen 1700 for a program host, for example, an MC. The host monitor screen 1700 is designed to provide information required for a program progress, and may provide a currently given question, a consultation, a question type, an example, correct answer information, the real number of participants, a correct answer rate, a participation rate for each age, and a participation status for each region.

Through the aforementioned UI screens associated with a monitor function, a manager and a host may easily verify a real-time participation status of a program or the overall information required for the program progress in person in a studio environment.

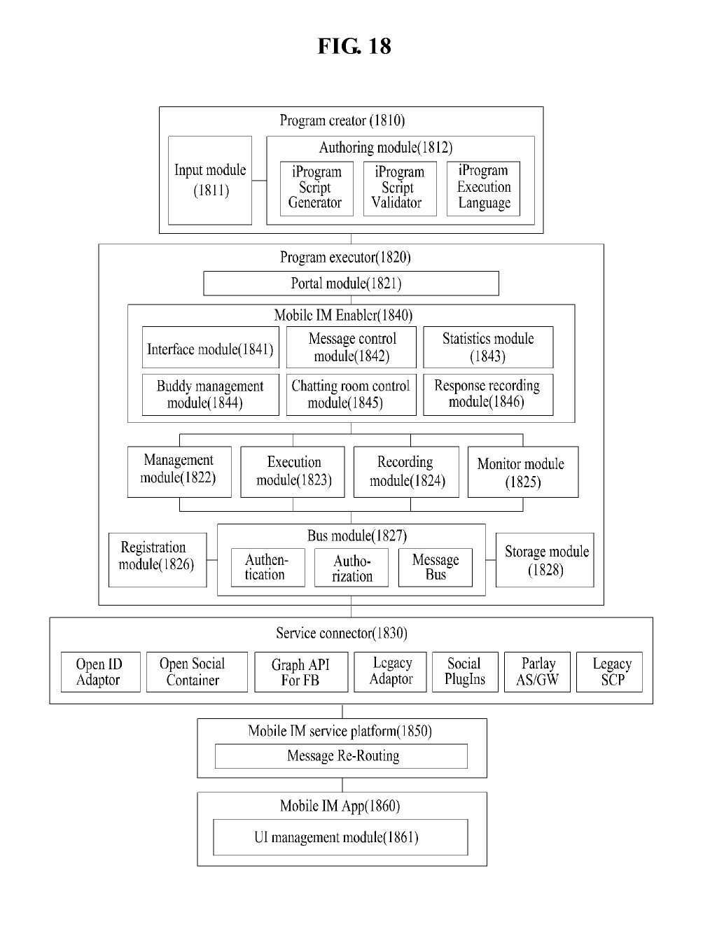

FIG. 18 illustrates a configuration of a program enabler service system including a mobile IM enabler 1840 as an example of an interactive service enabler. A description related to constituent elements described above with reference to FIG. 2 among constituent elements of the program enabler service system of FIG. 18 will be omitted.

Referring to FIG. 18, a service connector 1830 may connect to a mobile IM service platform 1850 through a legacy adaptor. That is, the legacy adaptor may provide an adaptor function through an interaction with a mobile IM platform service provider.

The mobile IM enabler 1840 may be included as an internal configuration of a program executor 1820 or may be configured as a separate system to interact with the program executor 1820. In the present embodiment, the mobile IM enabler 1840 may provide a communication channel with a user participating in a broadcast program, and may serve to open a chatting room for the broadcast program through a buddy setting with a user that is to participate in the broadcast program.

Referring to FIG. 18, the mobile IM enabler 1840 may include an interface module (Web-based GUI MO) 1841, a message control module (Message Control Function) 1842, a statistics module (Real-time Monitoring Function) 1843, a buddy management module (Buddy List Control Function) 1844, a chatting room control module (Chatting Room Control Function) 1845, and a response recording module (Score Recording Function) 1846.

The interface module 1841 provides a function capable of verifying information of users (buddies) participating in a program, a message reception/send status, and a response (correct answer/incorrect answer) of a user in a web-based GUI form.

The message control module 1842 may provide a function of triggering the participation intent of a user through a character string based filtering (message matching) and a function of determining whether a response of a participant is a correct answer or an incorrect answer. Also, the message control module 1842 may provide a function of sending a predetermined message to a user (buddy) through interaction message recognition on a program script. Here, a delimiter that enables an authoring module 1812 of the program creator 1810 to identify a type (for example, a question, a hint of the question, etc.) of a corresponding message needs to be created. For example, the message control module 1842 may read a delimiter capable of identifying whether a type of a message to send to a user is a question or a hint, and may indicate the read delimiter on the message displayed through a mobile IM application installed in a terminal of the user.

The statistics module 1843 may provide a statistical function such as the number of users participating in a program, a participation rate for each question, and a correct/incorrect answer rate in real time.

The buddy management module 1844 may provide a function of managing a list of buddies having set a relationship based on an ID on a messenger created by a manager with respect to the broadcast program. In this instance, when a user authentication function is required to set a relationship with a user, the buddy management module 1844 may interact with an authentication system through a legacy SCP or a legacy adaptor.

The chatting room control module 1845 may provide a function of opening a program chatting room for reading chatting room creation information associated with the broadcast program and then verifying whether a user included in a buddy list participates in a corresponding episode of the broadcast program. Here, the chatting room control module 1845 may individually open a program chatting room for each episode of the broadcast program. In the case of using a character string based filtering method, the chatting room control module 1845 may recognize an input of a predetermined character string among character strings input from the user through the program chatting room and may verify the participation intent of the user. Here, the predetermined character string to be used to verify the participation intent of the user may be registered in advance to the message control module 1842 by the program manager.

The response recording module 1846 may provide a function of recording a success/failure (correct answer/incorrect answer) of a response to a question for each user ID included in a buddy list of a manager ID. Also, the response recording module 1846 may provide a function of storing a hint answer received from a user to be distinguished from a question answer based on a separate flag as expressed by the following Table 1. Information recorded in the response recording module 1846 may be used to calculate statistical information in the statistics module 1843.

TABLE 1

| Field | Data Type | Description |
|---|---|---|
| ProgramID | Varchar (200) | Unique ID of broadcast program |
| PP_BuddyID | Varchar (200) | Representative buddy ID of |
| | | program provider |
| BuddyID | Varchar (200) | Buddy ID of answerer (user) |
| Question_Msg_No | Char (50) | Unique number of question |
| Answer_Correct | Boolean | Whether response to question is |
| | | correct or incorrect answer |
| HintAnswer | Boolean | Whether hint answer is present |

When providing an individual question, the mobile IM enabler 1840 constructed as above may determine whether to give a hint for a corresponding question based on a hint input status, and may employ a character string matching method as an example of the determining method.

As described above, when using a mobile IM as an interactive device with a user with respect to the broadcast program, a function capable of identifying and thereby displaying a message on a UI of the mobile IM is required. Accordingly, the mobile IM enabler 1840 may apply a different color for each message displayed on the UI of the mobile IM using a color index according to a progress time of the broadcast program or an event within the broadcast program through interaction with the program executor 1820 and the mobile IM service platform 1850. As an example, the mobile IM enabler 1840 may provide a color index designating a different color for each message that is classified based on a progress time of a broadcast program. In detail, the mobile IM enabler 1840 may provide a function of identifying, using a color, a before-broadcast message, a mid-broadcast message, and an after-broadcast message based on the progress time of the broadcast program. As another example, the mobile IM enabler 1840 may provide a color index designating a different color for each message that is classified based on an event associated with the broadcast program. For example, the mobile IM enabler 1840 may provide a function of identifying, using a color, a message requiring a response of a viewer, a message associated with program content, and a general notice and guide message irrelevant to a broadcast progress. Further, when a question is given in the broadcast program and the question includes hint information, the mobile IM enabler 1840 may also provide a function of identifying, using a color, a message associated with the question and a message associated with the hint information. The mobile IM enabler 1840 that provides the color index function may change at least one of a text color and a background color of a message as a method for identifying a message.

In a broadcast program environment that requires a user participation within a limited time, a function of providing additional information about a progress time of a broadcast program through a user interface (UI) of a messenger is required. Accordingly, the program executor 1820 may provide a user with time information associated with an interactive object (for example, a quiz, a survey, a vote, and an application) of the broadcast program based on a progress time of the broadcast program through a chatting room opened in the mobile IM enabler 1840. In addition, the program executor 1820 may additionally provide statistical information according to a user participation in the interactive object of the broadcast program. In the present embodiment, time information may indicate a remaining time in which the user is capable of inputting a message through a chatting room of a messenger as a user response to the interactive object. Statistical information may indicate real-time statistical data about a user response. As an example, when a question that requires a user to submit an answer within a limited time is given during a broadcast, a remaining time by a time at which a question solution is terminated based on a time at which the question is given is provided through the UI of the messenger. A variety of statistical data such as a real-time participation rate or a correct answer rate of the corresponding question may be provided on the entire participants.

Also, the mobile IM enabler 1840 is to provide a program participation function of a group unit through a mobile IM and thus, may provide various participation methods and question solution methods, such as receiving, from participants of a group chatting room, answers in order designated in the group chatting room using a characteristic of the group chatting room so that a user may participate in the broadcast program, or supporting a program participation when the number of participants is greater than or equal to the number of users designated based on a group unit. Accordingly, a participant may use an additional service through a participation of a group unit in a broadcast program, and a program provider may improve the concentration on a program and achieve a lock-in effect with respect to a program participant during an air time by limiting the number of users participating in a group. Also, the program provider may provide a customized service such as providing a product and giving a predetermined quiz question through a separate user management.

Referring again to FIG. 18, a mobile IM application 1860 installed in a terminal of a user may execute a chatting room of a corresponding program using an ID of a broadcast program the user is to participate in, and serves to display a message sent and received between the program enabler service system and the user on a screen of the executed chatting room. As illustrated in FIG. 18, the mobile IM application 1860 may include a UI management module (chatting UI manager) 1861.

In this instance, when an ID of a conversation partner requested by the user to create a chatting room is not a personal ID, for example, in the case of a special service such as an interactive broadcast program, the UI management module 1861 may provide a function of visually expressing participation information about the corresponding program by changing a chatting UI. To this end, the UI management module 1861 supports a function capable of changing a chatting room of a program participated in by the user using a background image or a window UI set by the program manager.

In particular, the UI management module 1861 may provide a UI environment including a plurality of input buttons as a UI for inputting a message of a user on a screen of a program chatting room, so that the user may input a message for each intent for participation in a broadcast program. A program participation intent using a mobile IM service may vary based on a characteristic of the broadcast program or an object (a quiz, a survey, a vote, and an application) that allows a user participation. However, in the present embodiment, the program participation intent may include an intent for inputting a response to a question given in the broadcast program, an intent for inputting a response to a hint when a question includes the hint, and an intent for inputting a simple chatting text such as a feeling as a participant of the broadcast program. As an example, the UI management module 1861 may provide a UI for inputting an “answer” to a question, and a separate UI for inputting a “response” to a hint, as UIs for a user input in a program chatting room. That is, the UI management module 1861 may provide a function of activating another button aside to a basic “send” button on a screen of the program chatting room, may activate the UI for inputting an “answer” to a question and in this instance, may verify whether the question is a hint giving question. In this instance, when the question is the hint giving question, the UI management module 1861 may also activate the UI for inputting a “response” to a hint. According to the above configuration, the user may send a message using a different input button for each participation type (for example, a question solution and a hint solution) required by the broadcast program. Accordingly, the program enabler service system may filter a message received from the user through a UI used for inputting the message in the program chatting room. That is, the response recording module 1846 may identify a user response to the question and a user response to the hint based on an input button used for inputting a message, and may store the response to the question and the response to the hint using separate flags as expressed by Table 1. In addition, through the program chatting room, the program enabler service system may inform the user regarding whether the message sent from the user is received, such as whether the response to the question is received or the response to the hint is received as a result of filtering the user response. Accordingly, a response target (that is, a question or a hint) and a message (for example, “Your answer to the question is registered.” or “Your answer to the hint is registered.”) indicating whether a message is received may be displayed as a response input result about the message sent from the user.

Also, the UI management module 1861 may control an activation of an input button based on a time at which the question or the hint is given or a participation time through interaction with the broadcast program by the program enabler service system. For example, when a user participation time for a question is designated as 3 minutes, a UI for inputting an “answer” may be activated immediately after the question is given and may be inactivated after 3 minutes is elapsed. As described above, since the program enabler service system receives and registers a message input with an activated button by selectively controlling an activation of a UI, it is possible to provide a user convenience with respect to a message input.

The UI management module 1861 may support a function of inactivating a hint message when a predetermined period of time is elapsed after receiving the hint message based on a characteristic of the hint and a function of providing a hint message one time in a marquee form, as an additional function associated with a hint UI on the screen of the program chatting room.

Further, when a message is received from the program enabler service system through the mobile IM service platform 1850, the UI management module 1861 may display the received message using a color designated for the corresponding message. For example, the UI management module 1861 may indicate a background color of a message in “white” in the case of a message received before a program broadcast starts and after the program broadcast is terminated, may indicate a background color of a message in “blue” in the case of a received message associated with a question given during a broadcast, and may indicate a background color of a message in “yellow” in the case of a general received message irrelevant to the question given during the broadcast. Further, when a hint is given for the question, the UI management module 1861 may indicate background colors of a received message associated with the question and a received message associated with the hint using different colors.

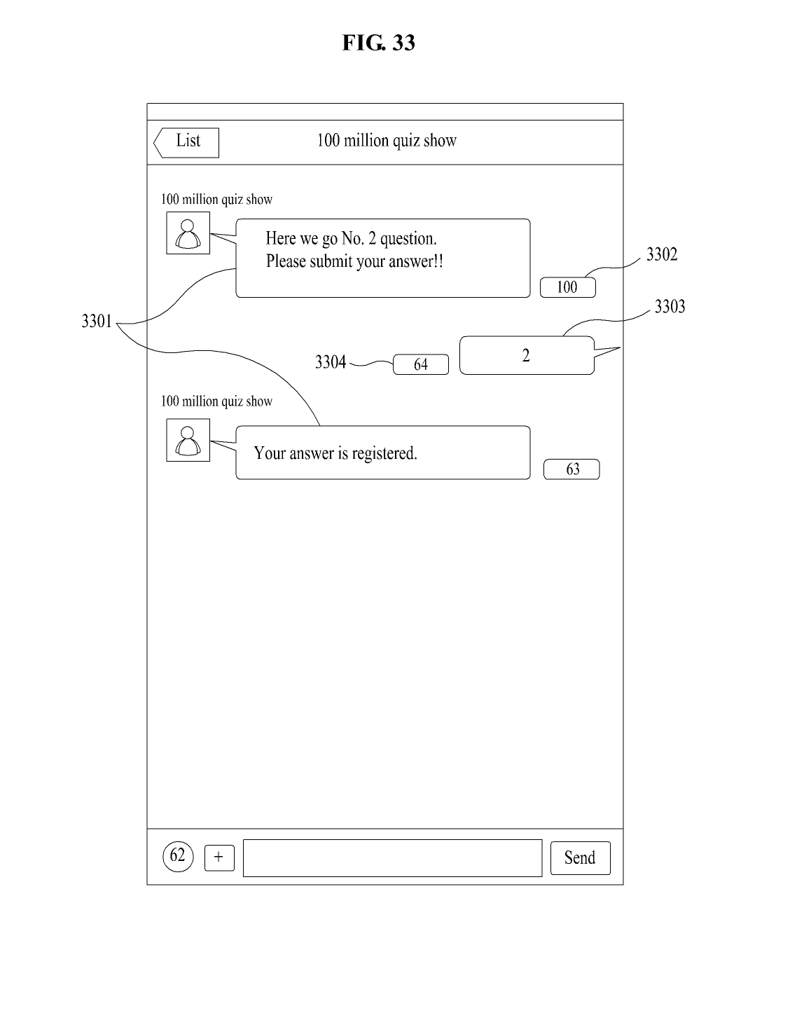

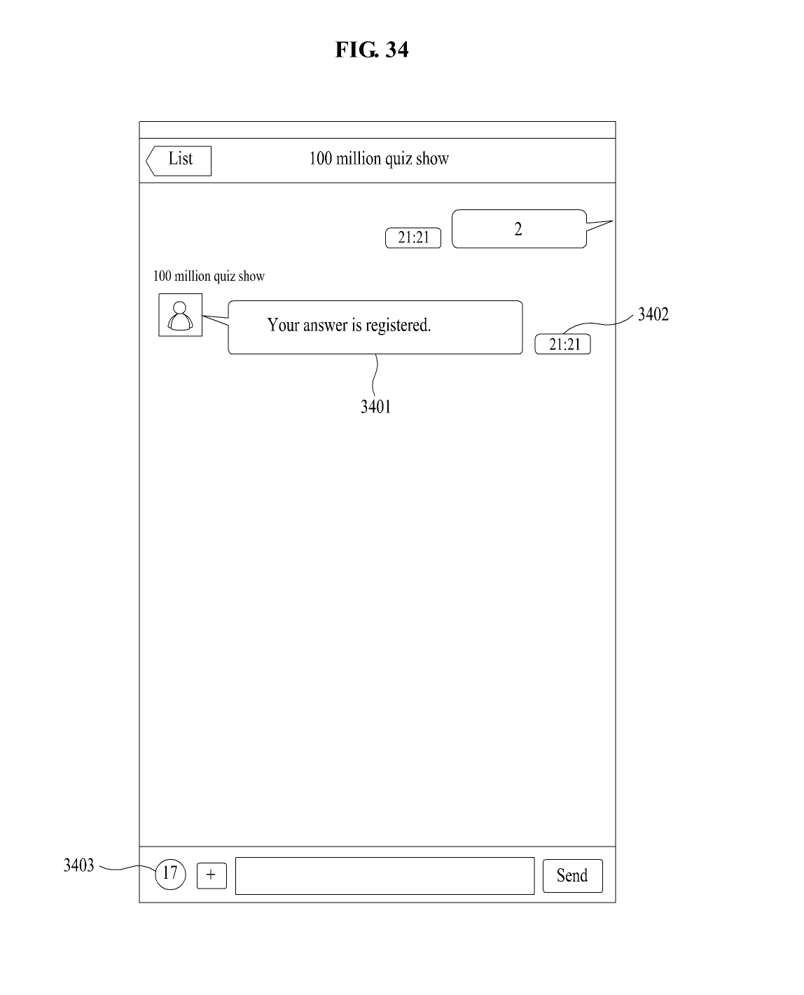

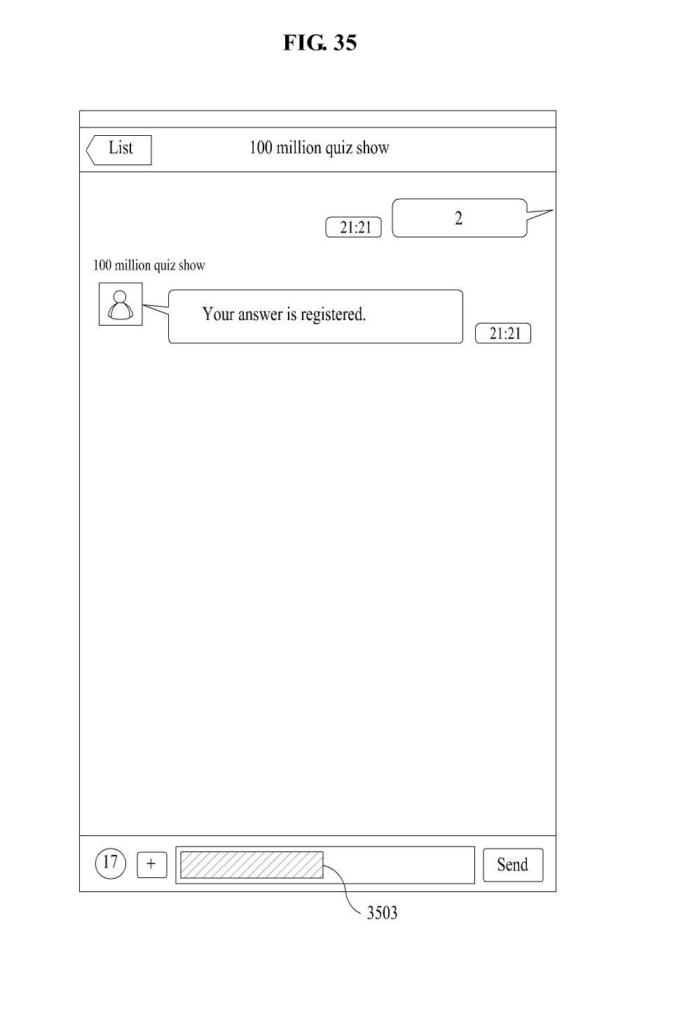

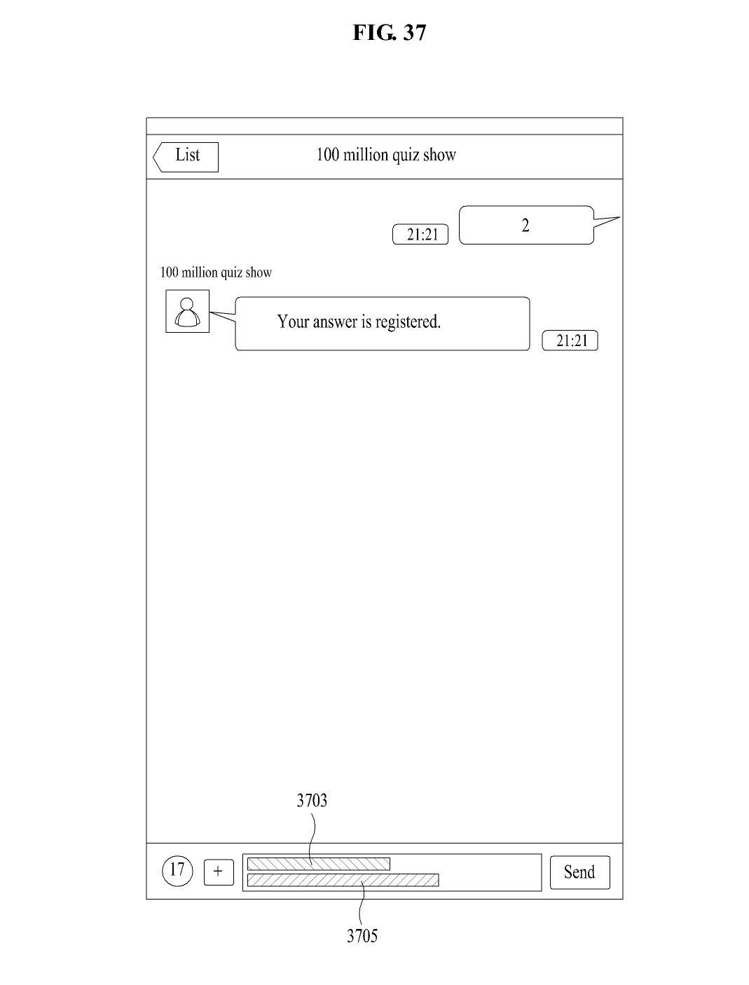

Also, when a message associated with a question given during a broadcast is received from the program enabler service system, the UI management module 1861 may display a remaining time in which the user is capable of inputting a message as a response to the question on a screen of a program chatting room. As an example, the UI management module 1861 may display a remaining time at each of a message received time and a message sent time at a location adjacent to each message for each of a received message and a sent message displayed on a screen of a chatting room (see FIG. 33). As another example, when a question given during a broadcast includes a query for giving a hint, the UI management module 1861 may classify and thereby display a remaining time in which the user is capable of inputting a response to the question and a remaining time in which the user is capable of inputting a response to the hint giving query, on the screen of the chatting room. As still another example, the UI management module 1861 may display a separate timer for counting the remaining time based on a unit time (for example, a second unit) on the screen of the chatting room (see FIG. 34). As still another example, the UI management module 1861 may display the remaining time in a form of a progress bar on the screen of the chatting room, so that the user may intuitively recognize information about the remaining time (see FIG. 35). As still another example, the UI management module 1861 may display the remaining time and statistical data using a progress bar on the screen of the chatting room so that the user may concurrently verify the remaining time and a progress status of the question (see FIG. 37). That is, the UI management module 1861 may display a different set of information (remaining time and statistical data) about the broadcast program using a double-progress bar. As still another example, the UI management module 1861 may provide information about the remaining time using a timer and may display statistical data using a progress bar so that the user may verify the remaining time and a progress status of the question. In the aforementioned examples, the timer and the progress bar may be displayed at a message input area of the chatting room or a location adjacent to the message input area, or may be displayed on at least one input button among UIs of the chatting room. Also, the UI management module 1861 may display the remaining time on the screen of the chatting room, and at the same time, may display a message received and a message sent time at a location adjacent to each of a received message and a sent message.

According to the present embodiment constructed as above, a mobile IM enabler is included as a communication channel for a broadcast program and thus, it is possible to support a user participation in a convenient environment by providing various communication functions and interface functions required for the corresponding broadcast program through a mobile IM service.

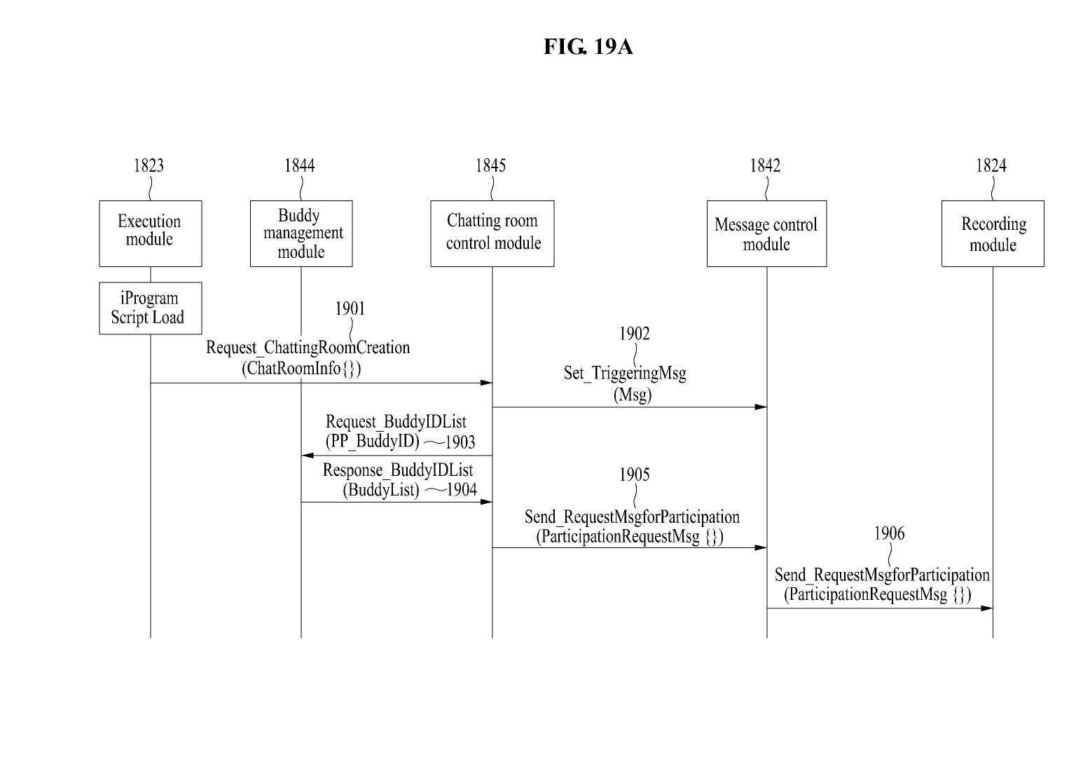

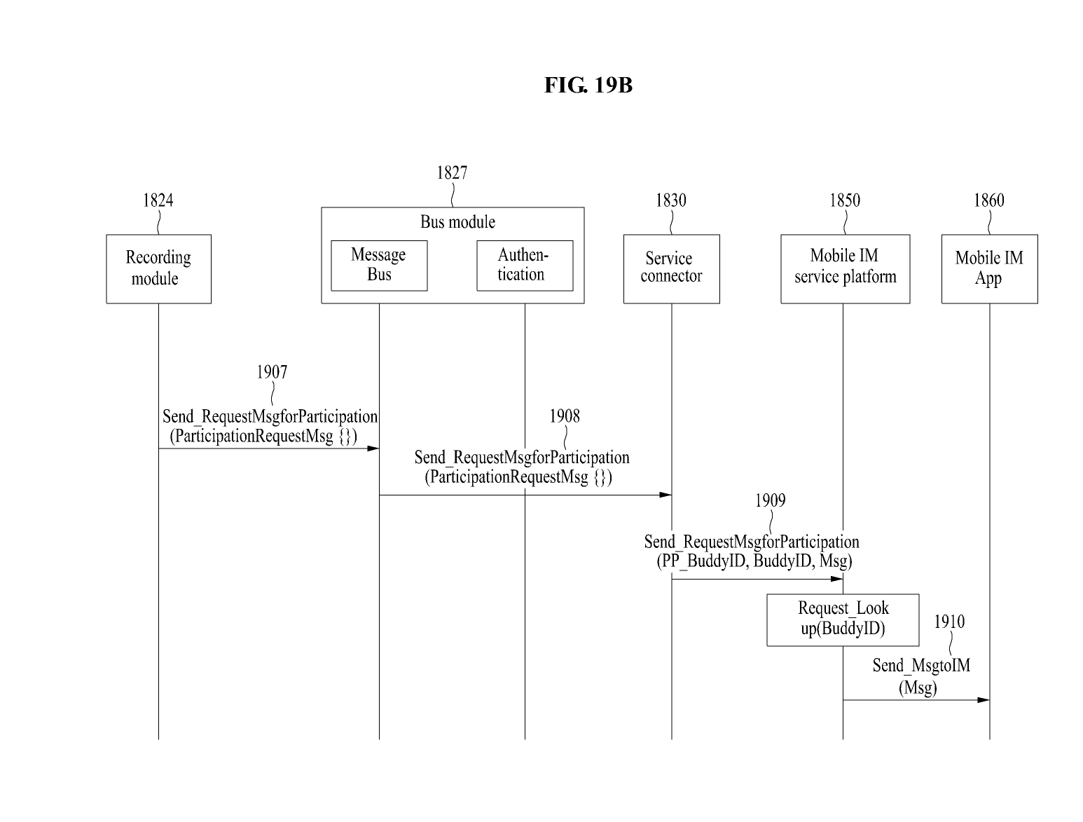

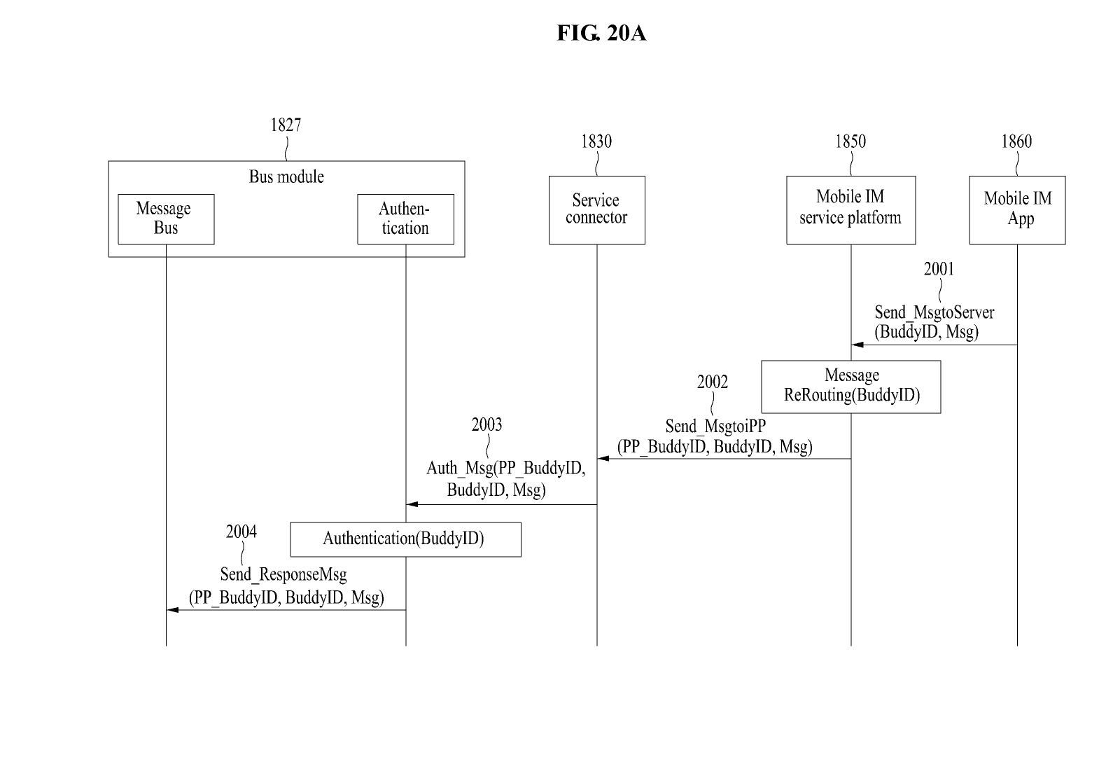

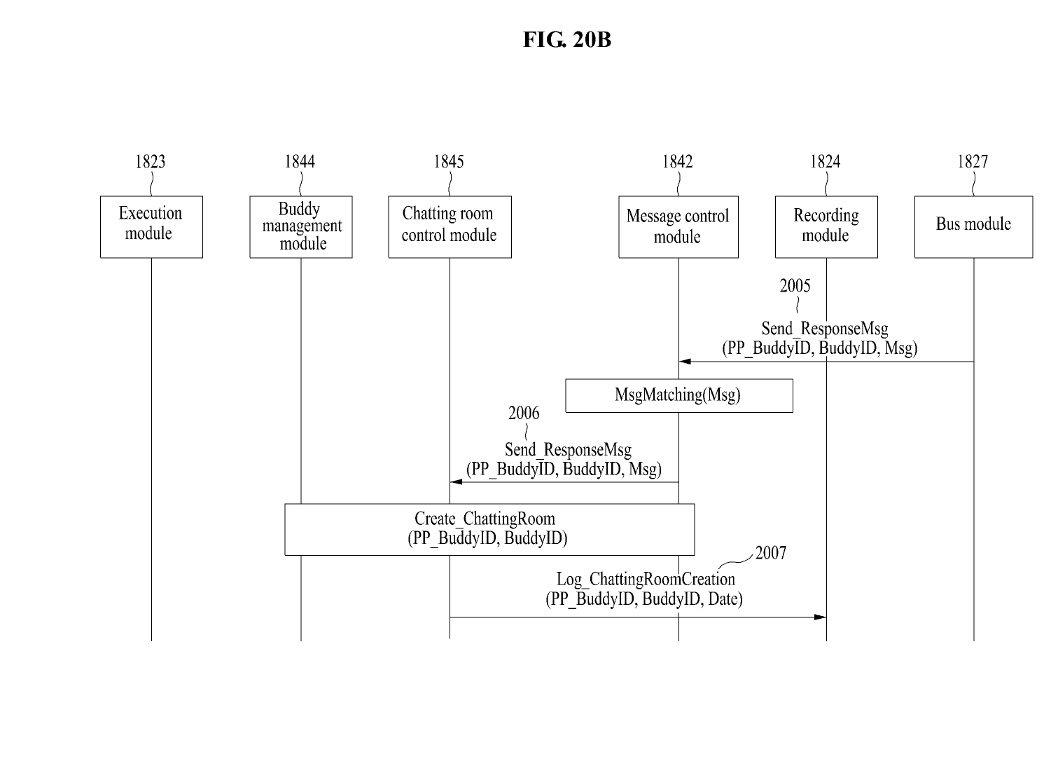

FIGS. 19A through 20B are flowcharts illustrating a process of creating a program chatting room in the program enabler service system of FIG. 18.

Referring to FIGS. 19A and 19B, an execution engine 1823 of the program executor 1820 loads program information provided in a script format from the program creator 1810 and requests the chatting room control module 1845 to create a chatting room of a corresponding program (1901). Here, in the case of initiating a user participation using a character string matching method, the chatting room control module 1845 transfers a predetermined character string preset by a manager to the message control module 1842 as a message for requesting a program participation, in response to the request of the execution engine 1823 (1902). Also, the chatting room control module 1845 requests the buddy management module 1844 for a list of buddies having set a relationship with respect to an ID of the program manager (1903). In response thereto, the buddy management module 1844 transfers the buddy list registered to the ID of the manager to the chatting room control module 1845 (1904). Accordingly, the chatting room control module 1845 sends, to the mobile IM service platform 1850, a message (hereinafter, a “participation request message”) for requesting all the users included in the buddy list for participating in a program. That is, the participation request message is sequentially transferred from the chatting room control module 1845 to the message control module 1842 of providing a function of identifying a message type, from the message control module 1842 to a recording module 1824 of providing an event recording function, from the recording module 1842 to a bus module 1827 of providing a message transfer function, and from the bus module 1827 to the mobile IM service platform 1850 through the legacy adaptor of the service connector 1830 (1905 through 1909). In this instance, the participation request message may be a predetermined character string preset by the manager. In response to the participation request message to a predetermined program received from the program enabler service system, the mobile IM service platform 1850 sends the participation request message to terminals (mobile IM application 1860) of all the users included in the buddy list of the manager (1910).

Referring to FIGS. 20A and 20B, the mobile IM application 1860 displays the participation request message received from the mobile IM service platform 1850, receives a response message to the participation request message from a user, and transfers the response message to the mobile IM service platform 1850 (2001). In this instance, the mobile IM service platform 1850 transfers the response message to the program enabler service system of the manager through a legacy adaptor of the service connector 1830 (2002). The response message of the user is sequentially transferred from the legacy adaptor of the service connector 1830 to the bus module 1827 of providing a user authentication and message sending function, and from the bus module 1827 to the message control module 1842 of providing a function of determining whether a character string matches (2003 through 2005). Here, in the case of initiating the user participation using a character string matching method, the message control module 1842 may determine whether a predetermined character string is included in the response message. The message control module 1842 receives the intent for participating in the program from a user using the character string matching method or a general push method, and requests the chatting room control module 1845 to create a chatting room (2006). Accordingly, the chatting room control module 1845 opens a program chatting room in which the user having expressed the participation intent through the response to the program participation message participates. The chatting room control module 1845 may open a program chatting room for each episode of the broadcast program. Here, log information (manager ID, a user ID, a created date, etc) of the opened program chatting room may be recorded in the recording module 1824 (2007).

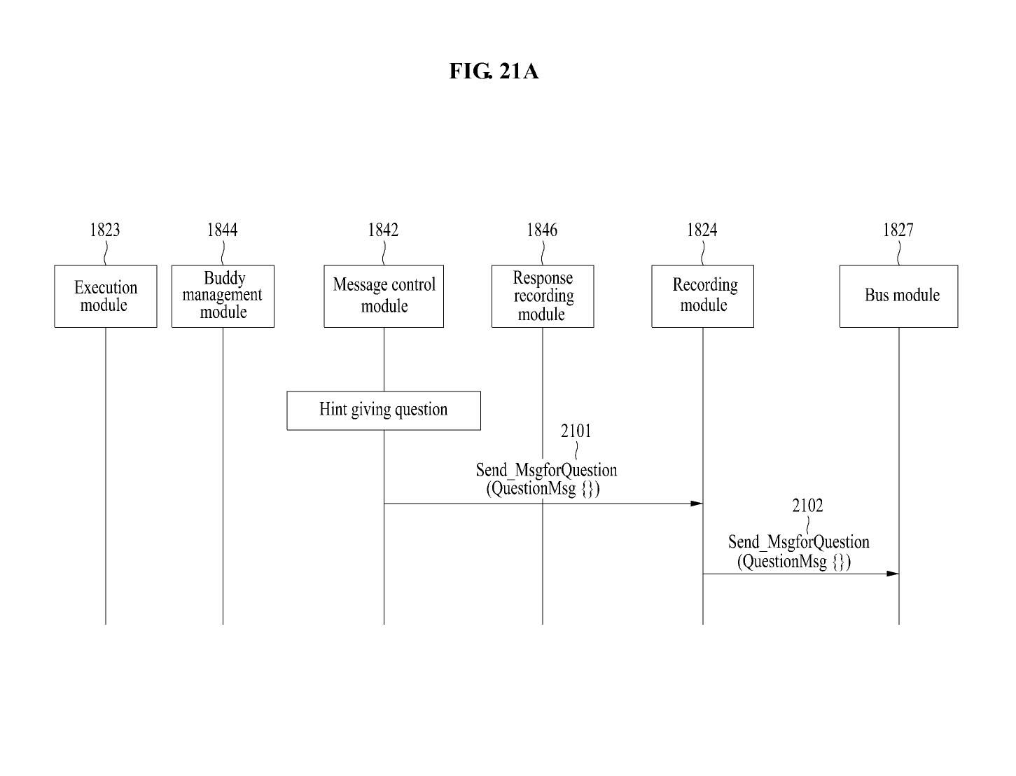

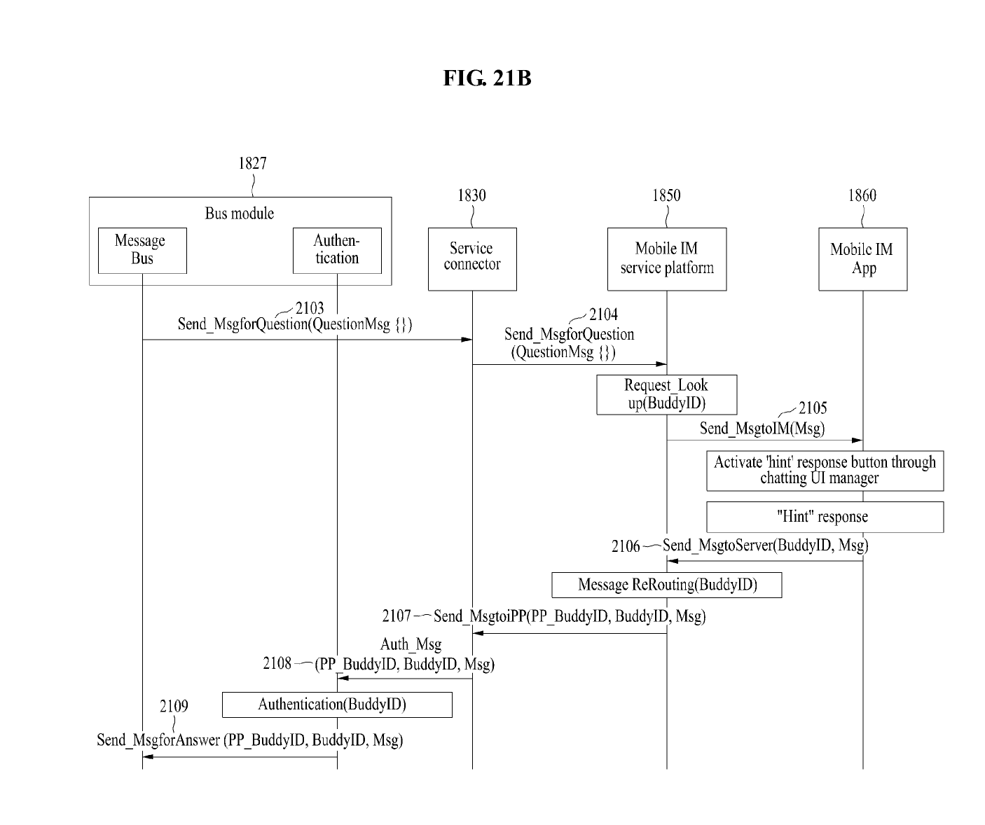

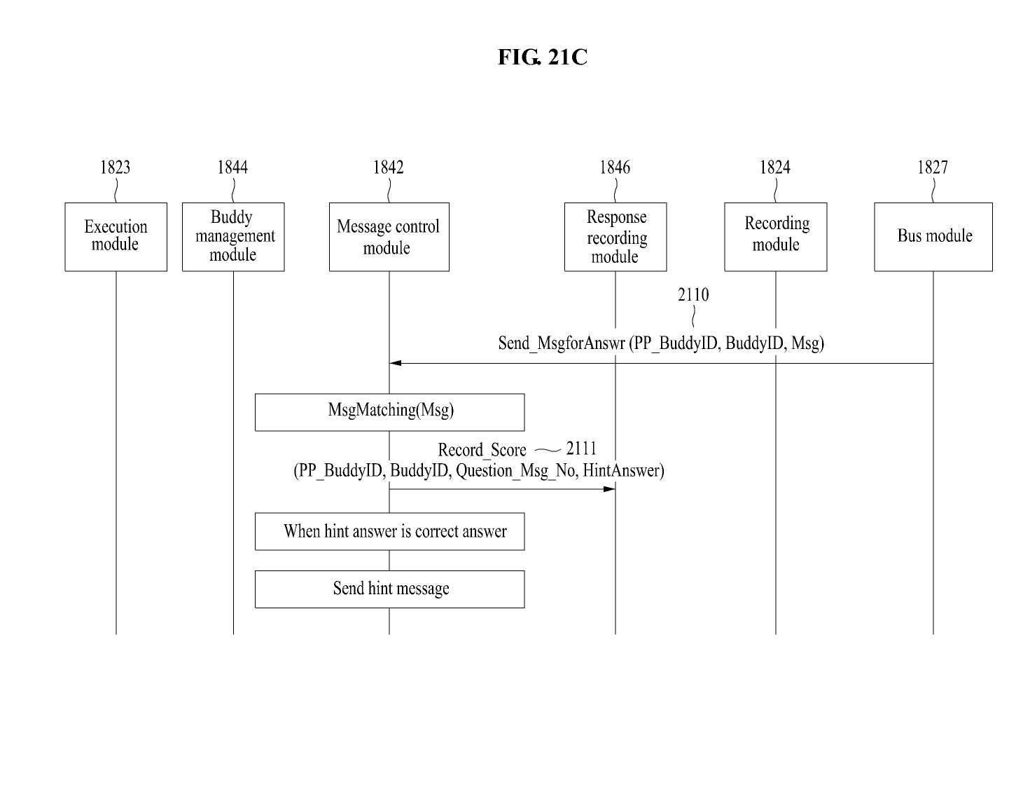

FIGS. 21A through 21C are flowcharts illustrating a process of providing a hint of a question in the program enabler service system of FIG. 18.

FIGS. 21A through 21C, when a question including a hint is given during a program execution, the message control module 1842 of the mobile IM enabler 1840 provides a query message (question message) for giving a hint. Here, the question message indicates a hint giving question preset by a manager. The hint giving question is sequentially transferred from the message control module 1824 to the recording module 1824 of providing an event recording function, from the recording module 1824 to the bus module 1827 of providing a message transfer function, and from the bus module 1827 to the mobile IM service platform 1850 through the legacy adaptor of the service connector 1830 (2101 through 2104). In response to the hint giving question received from the program enabler service system, the mobile IM service platform 1850 transfers the received hint giving question to a terminal (mobile IM application 1860) of a user participating in the program chatting room (2105).

The mobile IM application 1860 may activate a UI for inputting a “response” to a hint through the UI management module 1861 and may receive a “response” to the hint giving question from the user through the activated UI. Accordingly, the mobile IM application 1860 transfers the response of the user to the hint giving question to the mobile IM service platform 1850 (2106). The mobile IM service platform 1850 transfers the response message of the user to the program enabler service system of the manager through the legacy adaptor of the service connector 1830 (2107). The response of the user to the hint giving question is sequentially transferred from the legacy adaptor of the service connector 1830 to the bus module 1827 of providing a user authentication and message transfer function, and from the bus module 1827 to the message control module 1842 of providing a function of determining whether a character string matches (2108 through 2110). Here, the message control module 1842 may determine whether the response message received from the user to the hint giving question is a correct answer using the character string matching method. The message control module 1842 transfers the hint answer of the user to the response recording module 1846 to record whether the hint answer is a correct answer or an incorrect answer (2111). When the hint answer of the user is a correct answer, the message control module 1842 may send a hint message set for the hint giving question to a terminal (mobile IM application 1860) of the corresponding user through the aforementioned process (2101 through 2105).

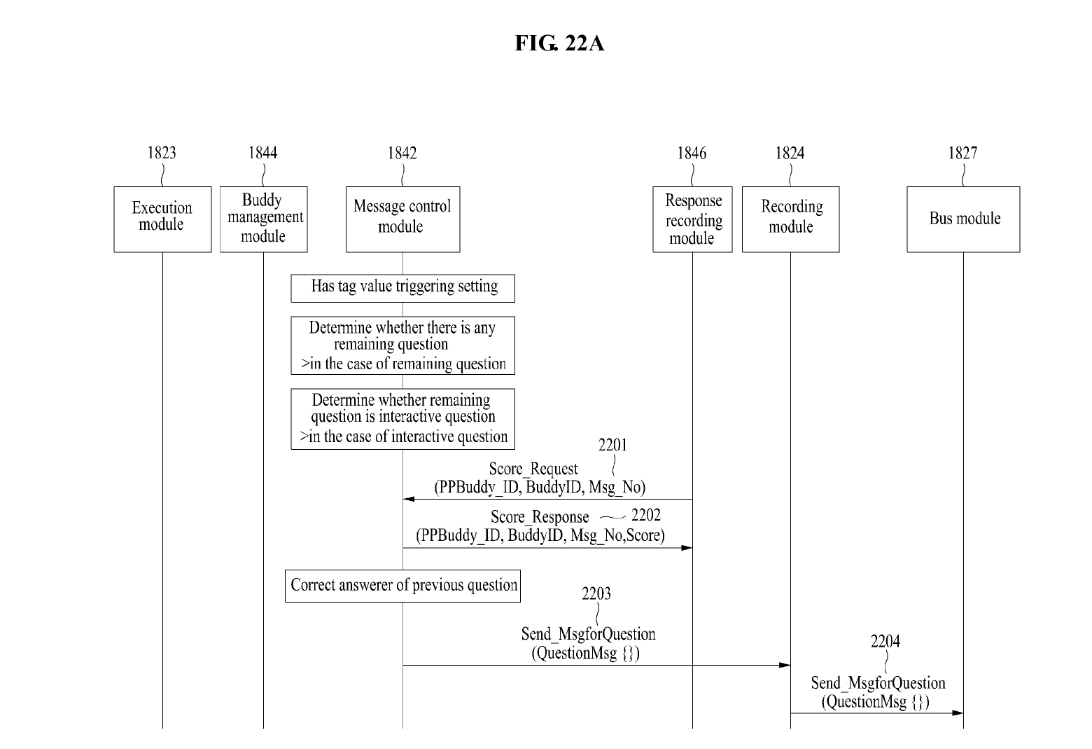

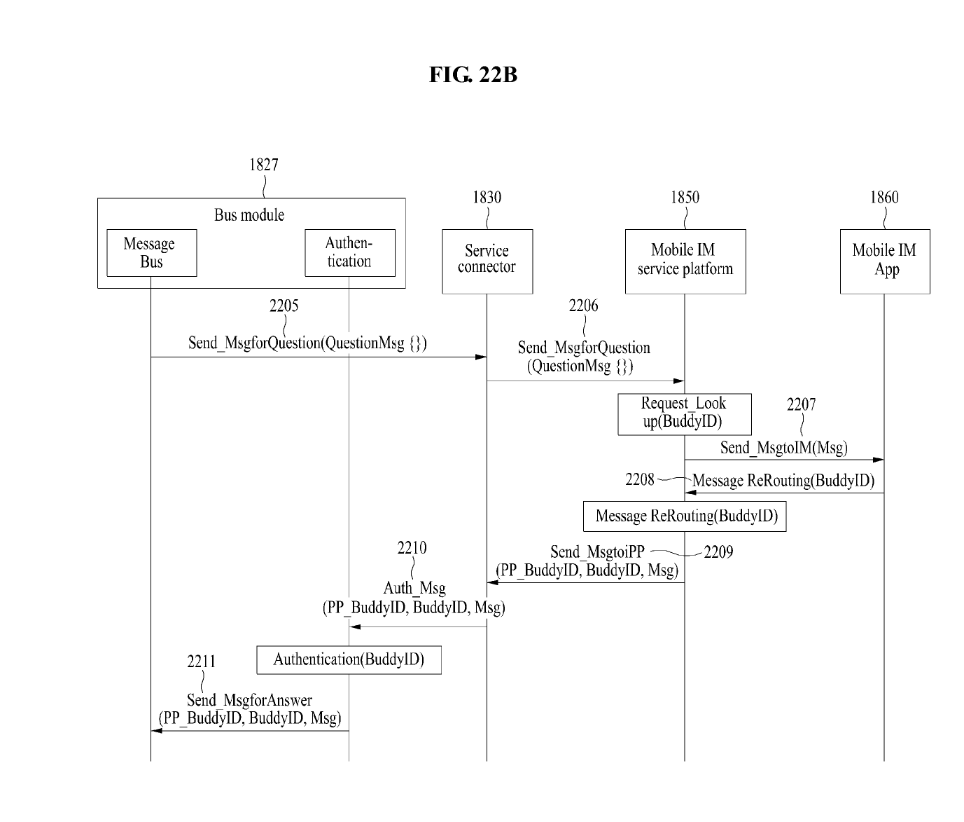

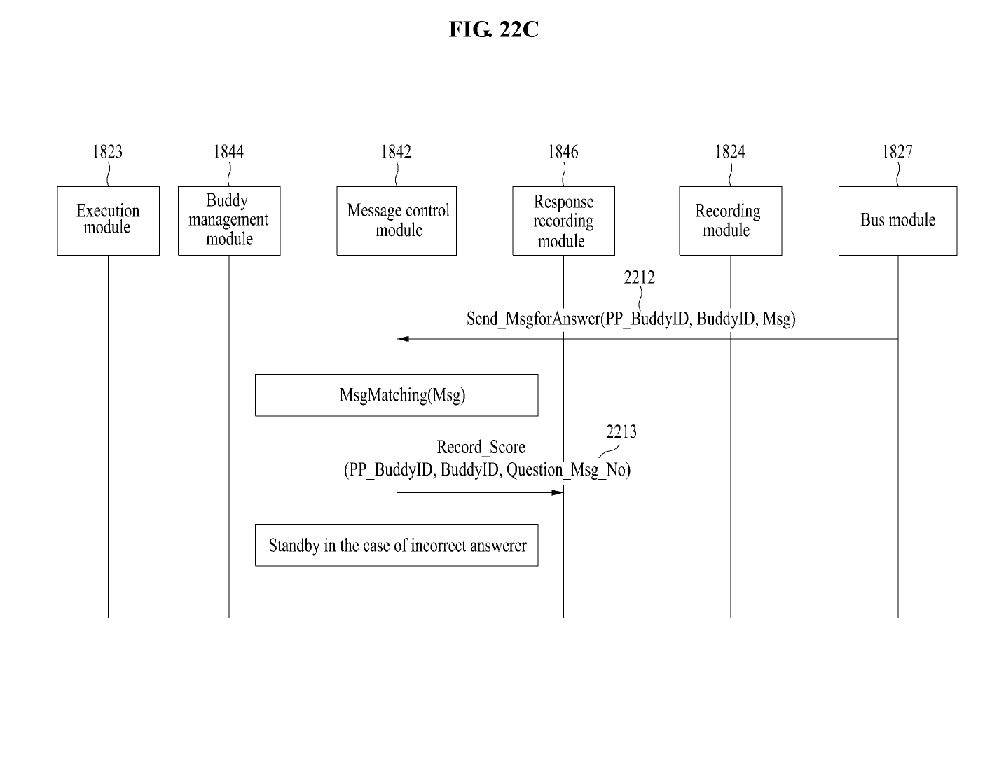

FIGS. 22A through 22C are flowcharts illustrating a process of providing an interactive question in which a condition is set between questions in the program enabler service system of FIG. 18.

Referring to FIGS. 22A through 22C, the message control module 1842 of the mobile IM enabler 1840 may determine whether there is any remaining question and whether the remaining question is an interactive question, and may request recording of a previous question when the remaining question to be given is the interactive question. As an example, the message control module 1842 may request the response recording module 1846 of providing a function of recording a correct answer or an incorrect answer for each user, to verify whether a response of a user to a previous question is a correct answer or an incorrect answer, or may request the statistics module 1843 of providing a statistical function for a correct/incorrect answer rate for each question, to verify a correct answer rate of the previous question (2201). The message control module 1842 may give a subsequent question based on records about the previous question, such as giving a subsequent question only to a user having sent a correct answer to the previous question through a response 2202 of the response recording module 1846, or giving a subsequent question based on a correct answer rate of the previous question through the response 2202 of the statistics module 1843. The given question is sequentially transferred from the message control module 1842 to the recording module 1824 of providing an event recording function, from the recording module 1824 to the bus module 1827 of providing a message transfer function, and from the bus module 1827 to the mobile IM service platform 1850 through the legacy adaptor of the service connector 1830 (2203 through 2206). In response to the question received from the program enabler service system, the mobile IM service platform 1850 sends the received question to a terminal (mobile IM application 1860) of a user having sent a correct answer to the previous question or a user participating in a program chatting room (2207).

The mobile IM application 1860 displays the question received from the mobile IM service platform 1850, receives a response message to the question from the user, and transfers the received response message to the mobile IM service platform 1850 (2208). In this instance, the mobile IM service platform 1850 transfers the response message to the program enabler service system of the manager through the legacy of the service connector 1830 (2209). The response of the user to the question is sequentially transferred from the legacy adaptor of the service connector 1830 to the bus module 1827 of providing a message transfer function, and from the bus module 1827 to the message control module 1842 of providing a function of determining whether a character string matches (2210 through 2212). In this instance, the message control module 1842 may determine whether the response message received from the user to the question is a correct answer using the character string matching method, and transfers the response message of the user to the response recording module 1846 to record whether the response of the user to the question is a correct answer or an incorrect answer.

Accordingly, the program enabler service system according to the present invention may support an environment capable of directly executing an interactive broadcast program produced using an editor for producing the interactive broadcast program through association between the editor and various services.

Hereinafter, a program enabler service method for providing a user participative interactive broadcast service will be described. Operations included in the program enabler service method according to the present invention may be performed by the program enabler service system of FIG. 18.

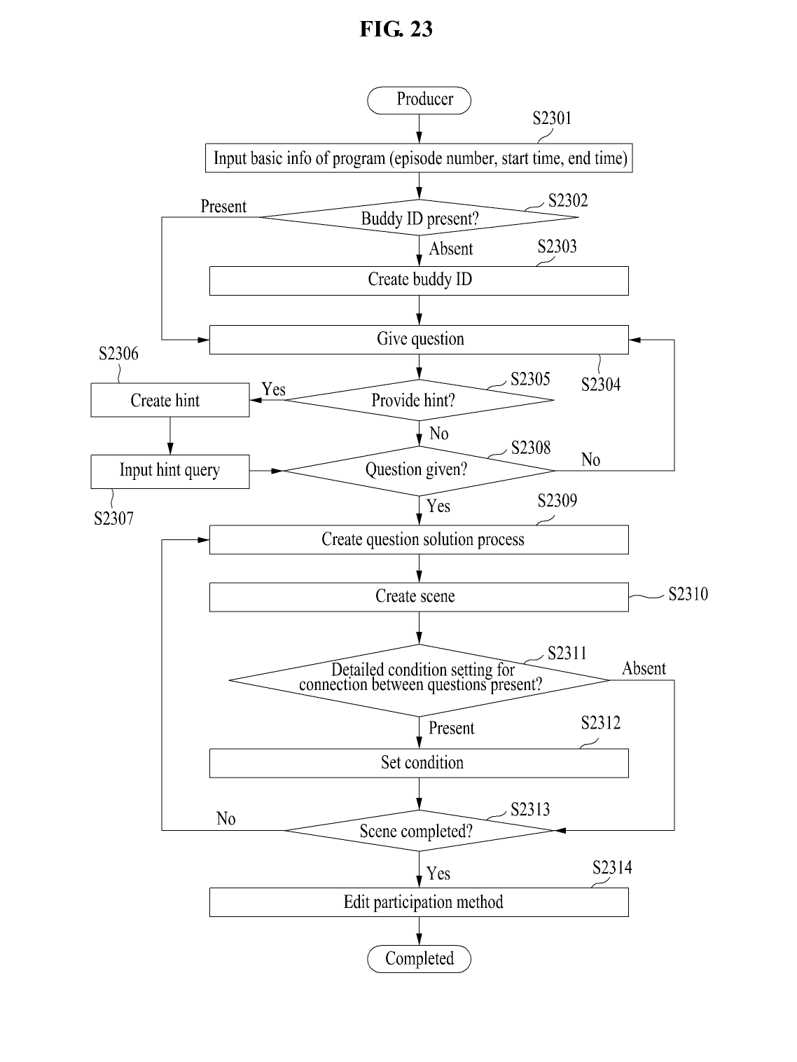

FIG. 23 is a flowchart illustrating a method of creating, by a producer, an interactive broadcast program according to an embodiment of the present invention.

Referring to FIG. 23, the program enabler service system may receive basic information of a program from a producer by providing an editor screen (FIG. 4/FIG. 6) for inputting basic information of the program in response to a request of the producer (S2301). In this instance, basic information of the program may include a name of the program, an episode of the program, cast information, and an air time (start time and end time). Here, the program enabler service system determines whether a buddy ID associated with the program is present (S2302), and creates a buddy ID of the program when the buddy ID is absent (S2303). When using a mobile IM as a communication channel with the user, a program manager is also regarded as a single buddy ID and the buddy ID associated with the corresponding program needs to be created to give a question and receive a response through the mobile IM.

When the buddy ID of the program input from the producer is already present or when the buddy ID of the manager is created through the above process, the program enabler service system may receive a question to be given from the producer by providing an editor screen (FIG. 6) for inputting a question to be given during a broadcasting (S2304). The program enabler service system may receive, from the producer, contents of a question, consultation, a type of the question, and examples of a multiple-choice question through the question screen. When the producer is to provide a hint as an option associated with the question, the program enabler service system may receive a hint text, a target to receive a hint, a hinting method, and a hint query through an editor screen (FIG. 8) for setting an option (S2305 through S2307).

When a question creation of the producer is completed (S2308), the program enabler service system may receive a question giving order and a question giving method from the producer by providing an editor screen (FIGS. 11 through 13) for setting a question solution process. That is, the program enabler service system may create an individual round (scene) for a predetermined episode of the broadcast program by creating a question solution process based on an input of the producer (S2309 through S2310). In this instance, when a detailed condition setting for connection between questions is required, the program enabler service system may receive a detailed condition associated with an interactive question from the producer through an editor screen (FIG. 13) (S2311 through S2312). For example, when questions A and B are set as a question to be given in successive to a previous question, a detailed condition for selecting a subsequent question may be set by the producer based on a correct answer rate of a first question.

Finally, when a creation of all the rounds for a predetermined episode of a broadcast program is completed through the aforementioned process, the program enabler service system may edit a user participation method with respect to the corresponding program (S2313 and S2314).

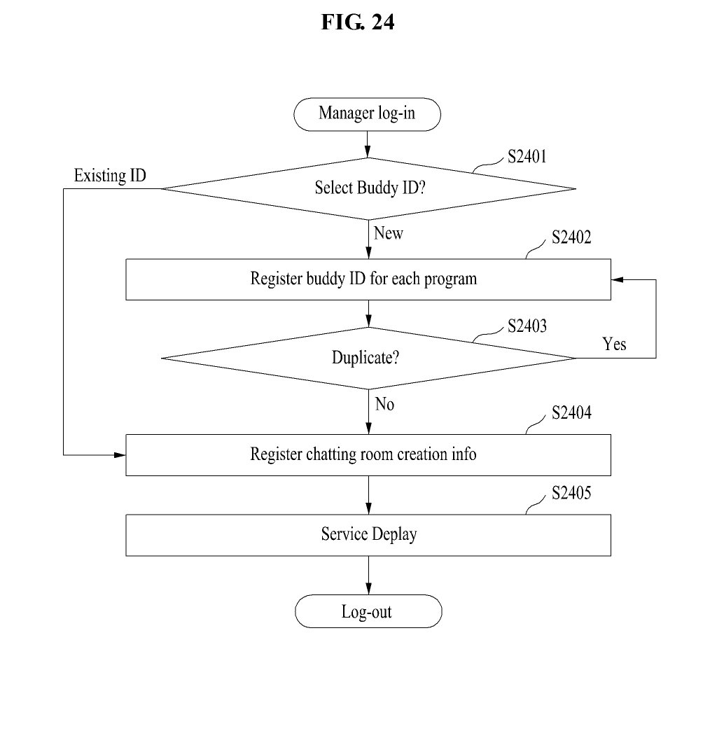

FIG. 24 is a flowchart illustrating a method of creating, by a program manager, a program ID according to an embodiment of the present invention.

The program manager refers to an operator operating an interactive service of a broadcast program, and is in charge of logging in the program enabler service system (that is, a portal module 1821) through a separate account and inputting and loading a basic interactive service creation condition.

Referring to FIG. 24, when a new program (or a new episode) is selected by a manager, the program enabler service system registers a new buddy ID for each corresponding program (S2401 and S2402).

In this instance, the program enabler service system may determine whether the buddy ID registered by the manager is duplicated, and may create a chatting room associated with the corresponding buddy ID when the buddy ID is determined not to be duplicated (S2403 and S2404). Accordingly, the program enabler service system may use the chatting room created based on the buddy ID of the manager as a communication channel for an interactive service of the corresponding program (S2405).

Accordingly, when using a mobile IM for an interactive service of a program, the program enabler service system may need to create a buddy ID of the manager and may create a chatting room (that is, a program participation room) based on the buddy ID of the manager.

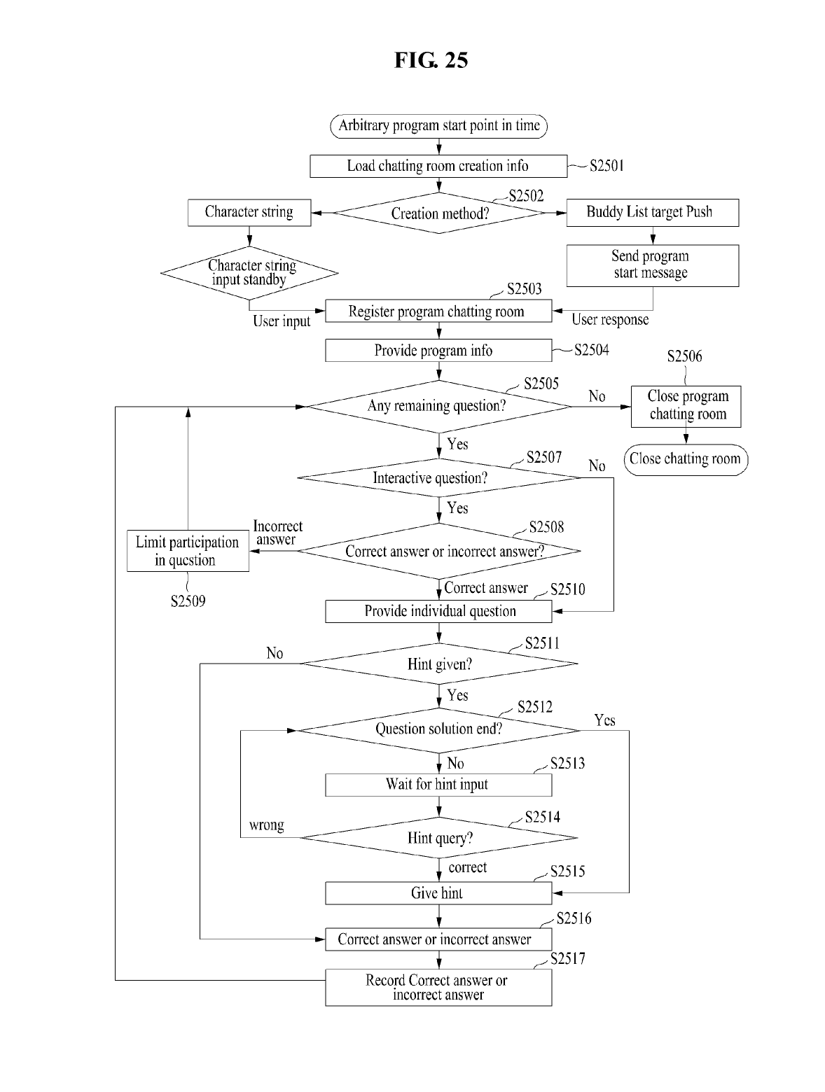

FIG. 25 is a flowchart illustrating a method of executing a broadcast program produced through an editor proposed herein in interaction with an interactive service enabler according to an embodiment of the present invention.

Referring to FIG. 25, a program enabler service system may load corresponding program information provided in a script format in order to create a chatting room for a predetermined program at an arbitrary time (S2501). That is, the program enabler service system may load chatting room creation information required for a corresponding episode by calling a service enabler (for example, the mobile IM enabler 1840) through a management module 1822 at an arbitrary program start time and by enabling the service enabler to load a program script created through the authoring module 1812.

The program enabler service system may determine a chatting room creation method (that is, whether to open a chatting room) and then may register a user as a participant in a corresponding program chatting room based on the determined chatting room creation method and number of users (S2502 and S2503). In the present embodiment, a predetermined character string input standby method and a buddy list push method may be used.

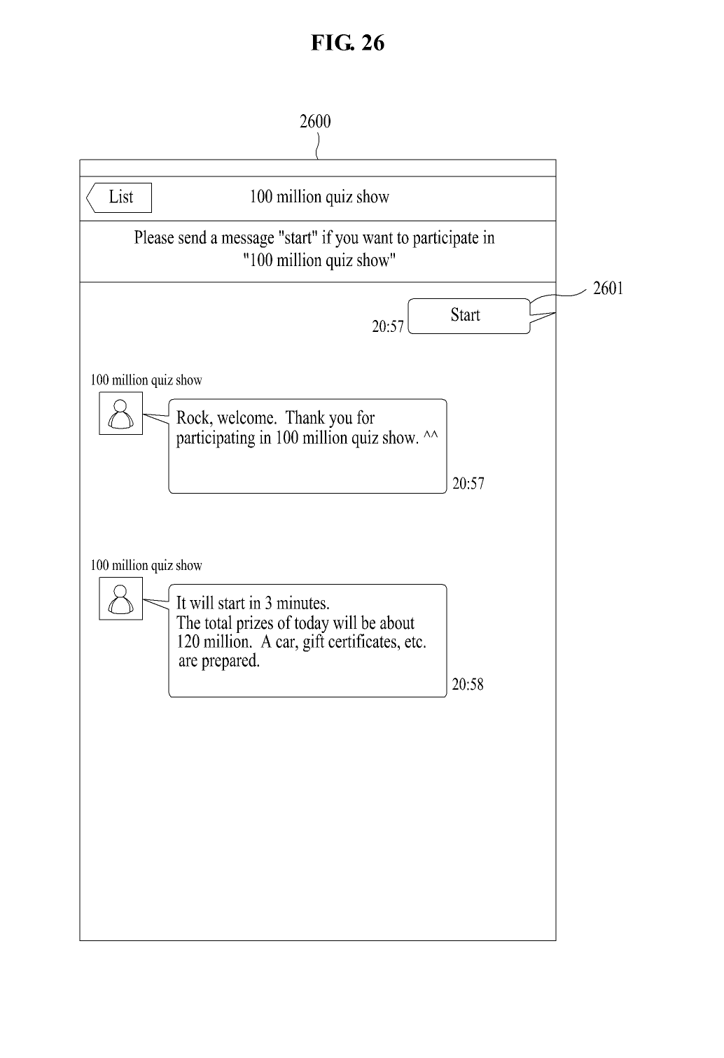

Referring to FIG. 26, in a predetermined character string input standby method, even though a program enabler service system does not send a separate message, a user may directly execute a corresponding chatting room 2600 using a program ID and may input a “character string” 2601 indicating a program participation intent. Here, the “character string” indicating the program participation intent is notified to all the users viewing a program. For example, “start” and “participate” may be used as a predetermined character string indicating the program participation intent. That is, a mobile IM enabler of the program enabler service system may determine whether a character string input from a user through a chatting room of a program ID matches the predetermined character string indicating a broadcast program participation intent and when they match, may set the user as a buddy of the program ID and allow the user to participate in the broadcast program through a corresponding chatting room. In this instance, when setting the user as the buddy of the program ID using the character string matching method, a buddy relationship with the program ID may be maintained during an air time of the broadcast program and a buddy setting with the user may be automatically canceled when the broadcast program is terminated.

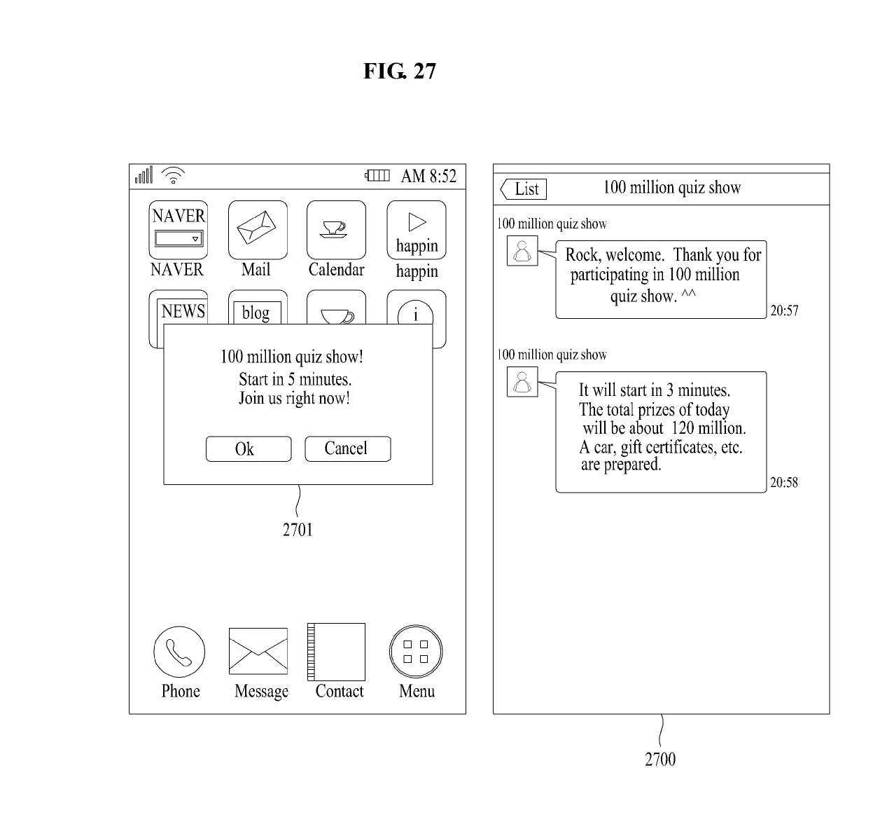

As another example, a buddy list target push method triggers a participation by sending a program start message to users having expressed a program participation intent in advance through making a friend with the program ID using the program enabler service system. Referring to FIG. 27, a program start message 2701 is pushed to all the users set as buddies and thus, a user may participate in a corresponding program by executing a chatting room 2700 at any time. That is, to trigger a participation in a broadcast program through a chatting room of the program ID, the mobile IM enabler of the program enabler service system may transfer a participation request message to users having set a buddy relationship in advance with the program ID using a message push method.

The program enabler service system may provide program information to users participating in the program chatting room (S2504). Here, in the case of a program that gives a question during an execution of the program, the program enabler service system determines whether there is any un-given question and closes the program chatting room when no question remains (S2505 and S2506). In contrast, when any question remains, the program enabler service system may provide a subsequent individual question. In addition, when any question currently remains and the remaining question is an interactive question that interacts based on a result of a previous question, the program enabler service system may determine whether a user response to the previous question is a correct answer or an incorrect answer, may limit a participation in the remaining question to a user having input an incorrect answer and may provide an individual question corresponding to the remaining question to a user having input a correct answer (S2507 through 2510).

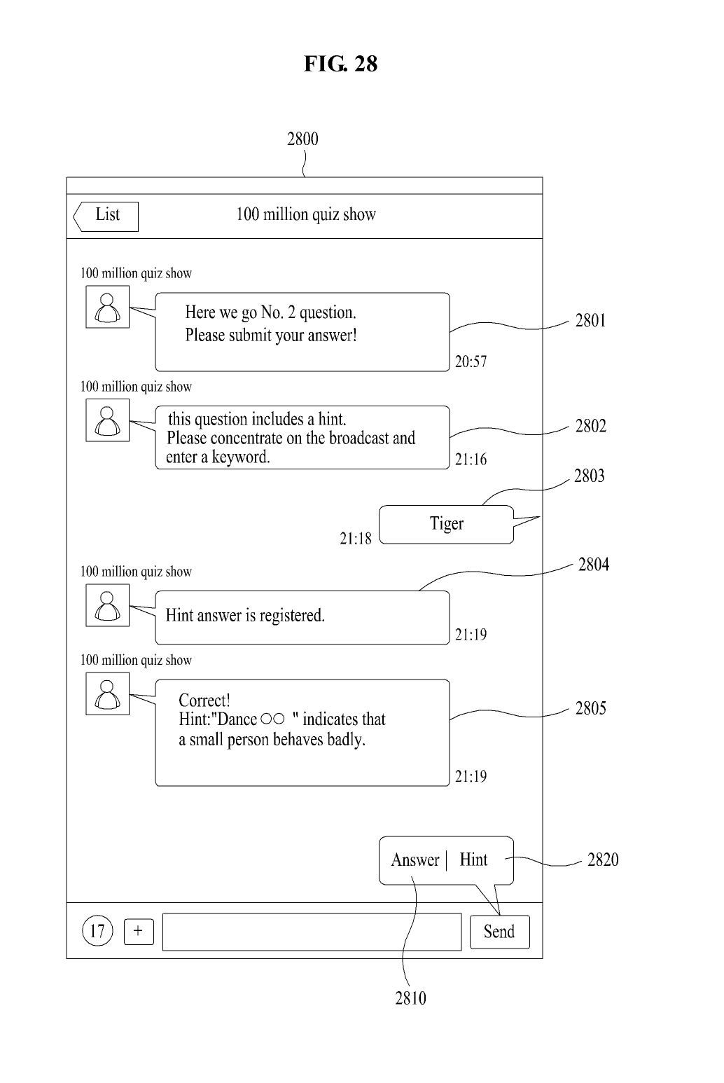

When a hint is set as a question option by a producer in providing a remaining individual question, the program enabler service system may provide a query for giving a hint through the program chatting room while a solution for the question given in operation S2510 is ongoing and then wait for an input of the user to the query (S2511 through S2513). Referring to FIG. 28, the program enabler service system may provide a message 2801 associated with the question through the program chatting room and then may provide a query 2802 for giving a hint when the question includes the hint. In this instance, the UI management module 1861 of the mobile IM application 1860 installed in a terminal of the user may provide an answer UI 2810 for inputting an “answer” to the question and a hint UI 2820 for inputting a “response” to the hint as UIs for a user input in a program chatting room 2800. As an example, when the user pushes long a “send” button that is a basic input button of a messenger, an “answer” input button 2810 and a “hint” input button 2820 may be activated and be displayed on a screen of the chatting room. Here, in a situation in which the user is to submit a response to the question, when the user inputs a message and pushes the “send” button, the corresponding response may not be submitted. When the user activates the answer UI 2810 and then pushes the corresponding button 2810, the response to the question is submitted. Similarly, in the case of the hint, a response to the hint is submitted through the hint UI 2820 instead of using the “send” button. That is, when the user creates a message in a program chatting room 2900 and then uses the answer UI 2810, the message may be input as the response to the question. When the user uses the hint UI 2820, the message may be input as the response to the hint. The program enabler service system may receive each response through a UI classified on the terminal of the user or using a separate combination of hash character string values.

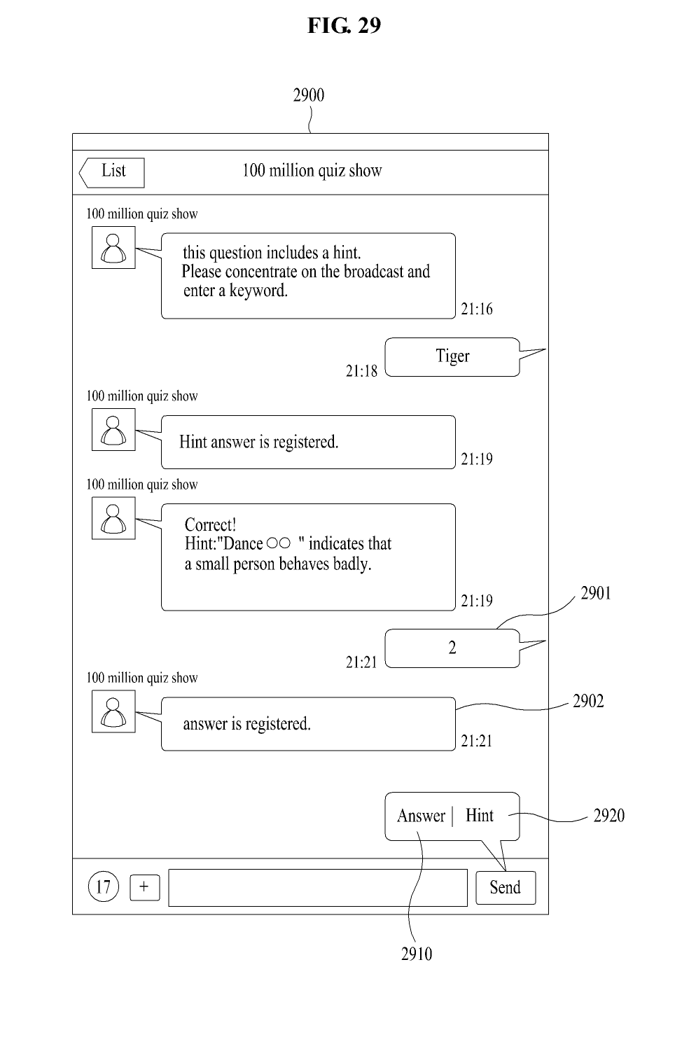

Accordingly, as illustrated in FIG. 28, when a response 2803 to a hint giving query is received from the user through the program chatting room 2800, the program enabler service system determines whether the response 2803 matches a hint query preset by the producer using a character string matching method (S2514). In this instance, when the response of the user to the hint giving query matches the preset hint query, the program enabler service system may give a hint 2805 of the question given in operation S2510 (S2515). Prior thereto, when receiving a response of the user, the program enabler service system may provide a message 2804 indicating that a response to a hint giving query is received through the program chatting room. When the hint of the question is given and a user response to the question given in operation S2510 is received, the program enabler service system may determine whether the received user response is a correct answer or an incorrect answer and may record a correct answer or an incorrect answer for each user (S2516 and S2517). As illustrated in FIG. 29, when the user inputs a response 2901 to the question through an answer UI 2910 in a state in which the answer UI 2910 and a hint UI 2920 are activated on a screen of the program chatting room 2900, the program enabler service system provides a message 2902 indicating that the response to the question is received. That is, the program enabler service system may classify a message sent from the user based on a program participation intent of the user (that is, the response to the question or the response to the hint) and thereby inform whether the message sent from the user is received.

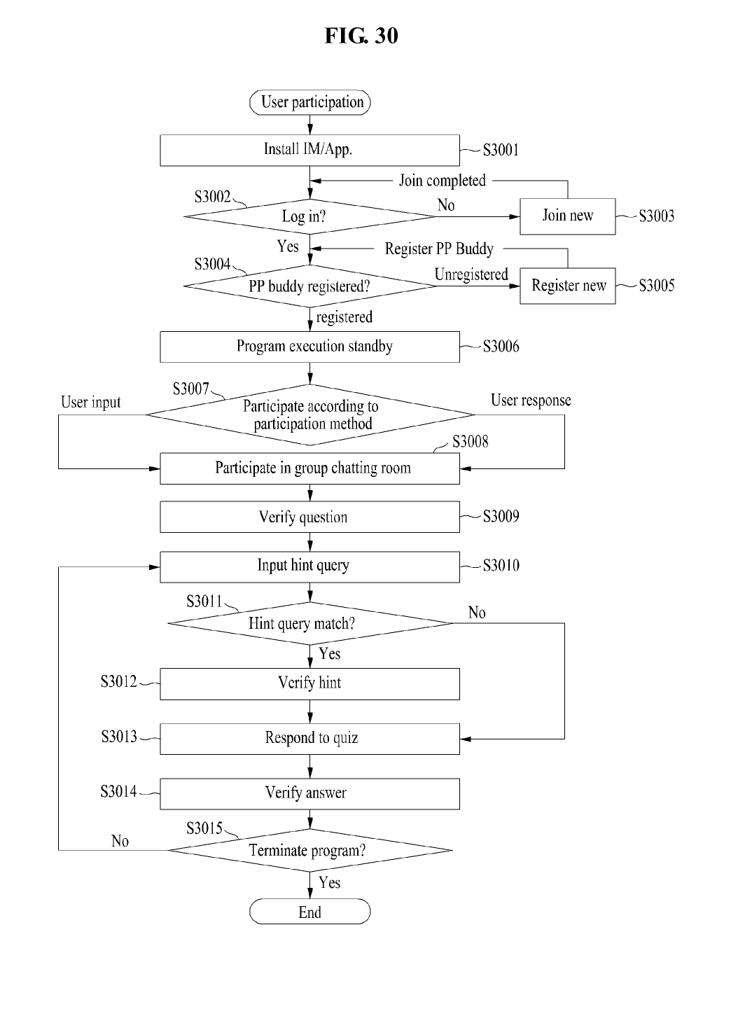

FIG. 30 is a flowchart illustrating a method of allowing a user to participate in a program on a terminal of the user according to an embodiment of the present invention.

Referring to FIG. 30, a user terminal installs a mobile IM application in response to a request of a user (S3001). In this instance, the mobile IM application, as a messenger program supported in a mobile environment such as Kakao Talk, Line, Tick Talk, and NATE ON, may indicate any type of messengers generally used. To participate in an interactive service program, the user needs to register a buddy ID of a corresponding manager to a buddy list through the mobile IM application installed in the terminal (S3002 through S3005).

The user terminal maintains a program execution standby state when an actual broadcast program is not initiated yet (S3006). Here, the program execution standby state may indicate a situation up to a time (for example, 5 minutes before the program starts) designated by the program manager.

When the actual broadcast program starts, the user terminal may execute a chatting of the corresponding program using a program participation method designated by the program manager for triggering the user to participate in a program through the mobile IM application (S3007 and S3008). In the present embodiment, the chatting room of the corresponding program may be executed using a predetermined character string input standby method (FIG. 26) and a buddy list target push method (FIG. 27). That is, in the case of using the predetermined character string input standby method, the user may participate in the broadcast program by directly executing a program chatting room using a program ID and by inputting a predetermined character string in the program chatting room. Also, in the case of using the buddy list target push method, the user may participate in the broadcast program by executing a program chatting room at a time when a participation request message is received from the program enabler service system in a state in which the user has registered the program ID to a buddy list of the user in advance.

The user terminal may receive a question given during a program execution from the program enabler service system, and may display the received question through the program chatting room of the mobile IM (S3009). Accordingly, the user may verify the question through a TV screen on which the corresponding program is on air and through the program chatting room of the mobile IM. Also, when the question is a hint giving question, the user terminal may receive a query for giving a hint from the program enabler service system and may display the hint query through the program chatting room (see FIG. 28). In this instance, the user terminal may receive the response to the hint query from the user and transfer the response to the program enabler service system, and may display, in the program chatting room, a hint of the question provided from the program enabler service system based on a hint query matching result, to be verifiable by the user (S3010 through S3012). When the user verifies the hint and inputs a response to the question, the user terminal may transfer the response to the program enabler service system and may display, in the program chatting room, an answer verification result provided from the program enabler service system to be verifiable by the user (S3013 and S3014).

The user terminal may maintain the user's participation in the program until the program is terminated (S3015). That is, even though the user executes another application after participating in the program chatting room, the program enabler service system recognizes that the user is to maintain the participation in the corresponding program unless the user selects a separate program participation end. Also, when a corresponding episode of the program is terminated after the user participates in the program chatting room, the program enabler service system may terminate an instance of a corresponding service and the user may leave the participating program chatting room. In this instance, when the user is to participate in a subsequent episode of the program in a state of maintaining a chatting room after the program is terminated, the user needs to express the intent regarding whether to participate in this episode. In this case, similarly, a participation character string input request message may be sent to the user and the user may participate in the corresponding program by inputting a character string.

The program enabler service system may provide a color index function for identifying a message during a process of executing a broadcast program in interaction with a mobile IM enabler. In the present embodiment, the program enabler service system may provide a color index designating a different color for each message classified based on a progress time of the broadcast program and/or an event occurring in the broadcast program.

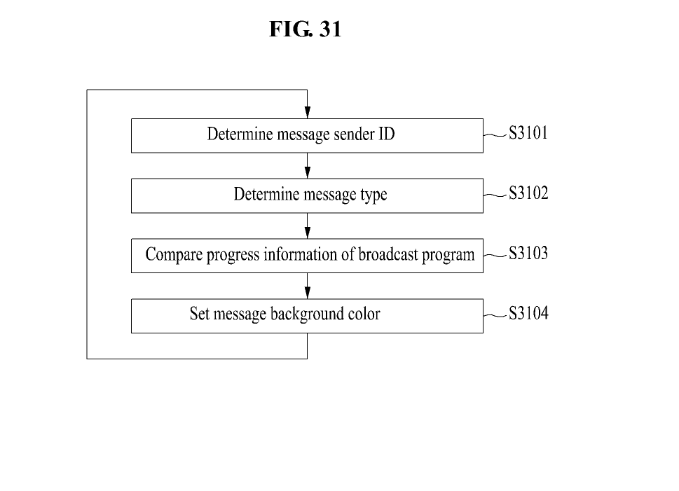

FIG. 31 is a flowchart illustrating a method of providing a color index function for identifying a message classification in a program chatting room in a program enabler service method according to an embodiment of the present invention. The method of providing a color index function may be configured through interaction with a mobile IM service platform that is an IM server, in a message filtering function area of the program enabler service system.

Referring to FIG. 31, the mobile IM service platform may determine an ID of a message sender (S3101) and may apply a color index function to a message when displaying the message in a chatting room. That is, the mobile IM service platform may determine whether the message is a message of a personal user ID or a message of a program ID (an ID of a program manager). Here, when the message is a message sent from the ID of the personal user, the mobile IM service platform may apply a default color supported at the platform. For example, with respect to messages sent and received between IDs of personal users, the mobile IM service platform may indicate a received message in “white” on a screen of a messenger chatting room and may indicate a sent message in “green” on the screen of the messenger chatting room. Similarly, with respect to messages sent and received between the ID of the personal user and the program ID, the mobile IM service platform may indicate a message sent from the personal user in “green” on a screen of a chatting room of a user side.

Here, when a message sender ID is a program ID created by a program manager, it is possible to identify and thereby display a message using a color index supported at the mobile IM enabler of the program enabler service system. In detail, when the message sender ID is a program ID, the program enabler service system may determine a type of a sent message in response to a request of the mobile IM service platform. Here, the program enabler service system may determine the type of the sent message as, for example, a message requiring a response of the user (a message associated with a question or a message associated with a hint of the question) and a general notice and guide message, based on an event within the broadcast program (S3102). In addition, the program enabler service system may categorize the type of the message into, for example, a before-broadcast message, a mid-broadcast message, and an after-broadcast message based on an actual broadcast service time that is based on progress information of the broadcast program (S3103). The program enabler service system may set a color for each message based on the type of the message determined during the above process (S3102 and S3103) (S3104). Here, the program enabler service system may change at least one of a text color and a background color of the message when applying a color based on a color index for each message.

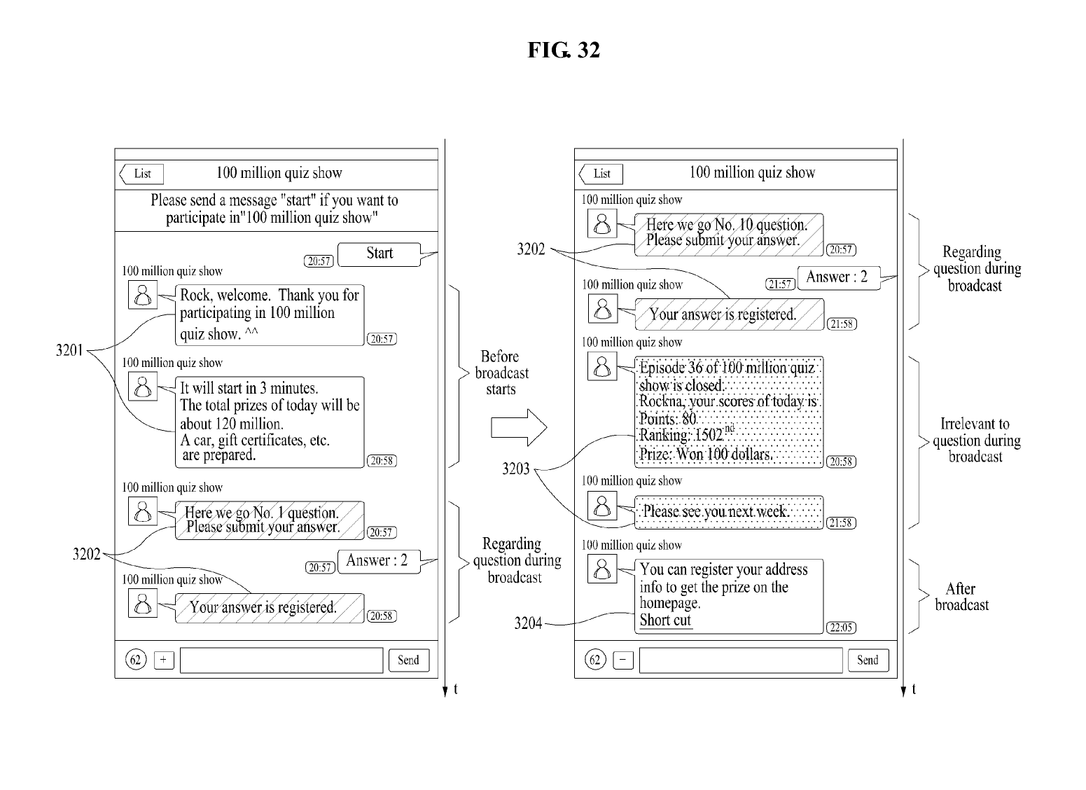

Accordingly, when displaying the message received from the program enabler service system on the screen of the program chatting room, the UI management module 1861 of the mobile IM application 1860 installed on the terminal of the user may display the message using a color set for the corresponding message. For example, referring to a screen of a chatting room of FIG. 32, in the case of a before-broadcast message 3201 and an after-broadcast message 3204a message background color may be displayed in “white”. In the case of a message 3202 that is a mid-broadcast message and also associated with a question given during a broadcast, a message background color may be displayed in “blue”. In the case of a message that is a mid-broadcast message and is irrelevant to the question, a message background color may be displayed in “yellow”. Also, in the case of a message (not shown) that is a mid-broadcast message and associated with a hint, a color index may be assigned so that a message background color may be set using a color, for example, “green” different from the message 3202 associated with the question that is displayed in “blue”.

As described above, for convenience of a user participating in a broadcast program, it is possible to provide a color index according to an air time of the broadcast program or an event within the broadcast program so that a message may be identifiable on a screen of a chatting room of mobile IM. The color index function of the above process may also be directly configured in the mobile IM service platform in interaction with the program enabler service system.

When sending/receiving a message to/from the user through a messenger during a process of executing a broadcast program in interaction with the mobile IM enabler, the program enabler service system may provide at least one of time information (that is, a remaining time until a question solution is terminated) about a question given during a broadcast and real-time statistical data according to a user participation in the question, based on a progress time of the broadcast program. Accordingly, the UI management module 1861 of the mobile IM application 1860 installed on the terminal of the user may display the remaining time and/or statistical data on the screen of the program chatting room.

As an example, referring to FIG. 33, the UI management module 1861 may display remaining times 3302 and 3304 at a message received time and a message sent time at locations adjacent to a received message 3301 and a sent message 3303 on a screen of a chatting room. For example, when a question is given during a broadcast, the message 3301 indicating that the question is given may be displayed through the chatting room of the messenger. At the same time, the remaining time 3302 until a deadline after the question is given may be indicated based on a second unit. When the remaining time 3302 is “100”, it indicates that the response will be acknowledged when the user submits the response within “100” seconds. Also, when the user submits the answer through the message 3303 about the corresponding question, the remaining time 3304 until a deadline after the answer is submitted may be displayed. That is, the UI management module 1861 may display a remaining time recorded based on a message received/sent time with respect to each of messages sent and received between the program enabler service system and the user. Further, when the question given during the broadcast includes a hint giving query, the UI management module 1861 may display a remaining time by an answer submission deadline of the question and a remaining time by an answer submission deadline of the hint giving query.

As another example, referring to FIG. 34, the UI management module 1861 may provide information about a remaining time by displaying a timer 3403 on a screen of a chatting room. In this instance, using the counter 3403, a remaining time by an answer submission deadline of a question may be counted based on a unit time (for example, a second unit) and thereby displayed. The timer 3403 indicating the remaining time may be displayed on an area (a message input column) in which the user inputs a message in the chatting room or at a location adjacent to the message input column. Also, the UI management module 1861 may display the remaining time using the timer 3403 and at the same time, may display a message received/sent time 3402 for each message 3401 sent and received between the program enabler service system and the user.

As still another example, referring to FIG. 35, the UI management module 1861 may display a remaining time by an answer solution deadline of a question in a form of a progress bar 3503 on a screen of a chatting room so that the user may intuitively recognize information about the remaining time. In this instance, the progress bar 3503 indicating the remaining time may be displayed on a message input column or a predetermined area on which a received/sent message is displayed in a chatting room, and may be represented in a form in which a bar extends from the left to the right or decreases from the right to the left according to a time count. Also, the UI management module 1861 may display the remaining time using the progress bar 3503 and at the same time, may display a message received/sent time with respect to each message sent and received between the program enabler service system and the user.

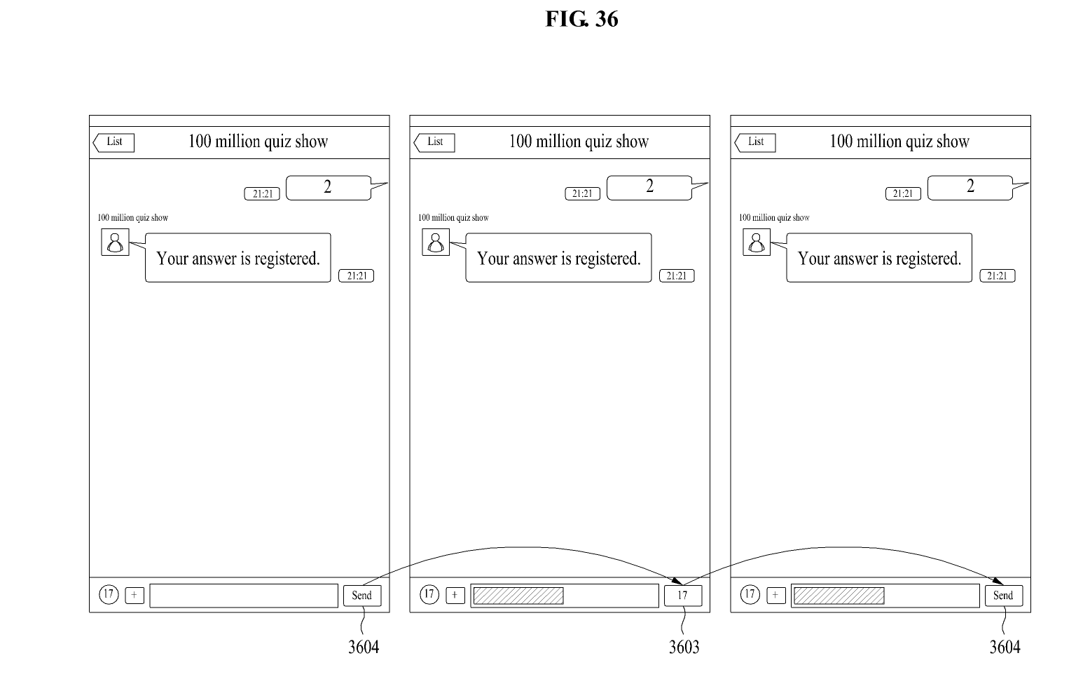

As still another example, referring to FIG. 36, the UI management module 1861 may display a timer 3603 indicating a remaining time by an answer submission deadline on at least one input button of UIs of a chatting room. For example, the timer 3603 indicating the remaining time may be displayed on a “send” button 3604 that is a UI used to send a message input from the user to a conversation party. In this instance, while the corresponding button 3604 is being flickered, the remaining time may be alternately displayed on a text on the “send” button 3604. Also, the UI management module 1861 may display the remaining time through the “send” button 3604 of the chatting room and at the same time, may display the message received/sent time with respect to each message sent and received between the program enabler service system and the user.

As still another example, referring to FIG. 37, the UI management module 1861 may immediately display each of a remaining time 3703 and statistical data 3705 using a progress bar on a screen of a chatting room so that the user may concurrently verify a remaining time and a progress status of a question. In this instance, the progress bars indicating the remaining time 3703 and the statistical data 3705, respectively, may be displayed on a message input column or a predetermined area on which a received/sent message is displayed in the chatting room. The progress bar indicating each different set of information may be represented to extend from the left to the right or to decrease from the right to the left based on a characteristic of information. For example, the progress bar indicating the remaining time 3703 may be represented to decrease from the right to the left, whereas the progress bar indicating the statistical data 3705 may be represented to extend from the left to the right. Meanwhile, the UI management module 1861 may display statistical data using a progress bar and may display a remaining time using a separate timer. Also, the UI management module 1861 may concurrently display the remaining time 3703 and the statistical data 3705 using the progress bars, and may also display a message received/sent time with respect to each message sent and received between the program enabler service system and the user.

As described above, for convenience of a user participating in a broadcast program, it is possible to effectively display information about a progress time of the broadcast program on a screen of a program chatting room using a variety of means such as a timer and a progress bar.

Hereinafter, an interface for a participation of a group unit in an interactive broadcast program will be described.

In the case of a participation of a group unit, the program enabler service system may determine the number of users designated for a group through the aforementioned process (S2502 and S2503) of FIG. 25, and may register a user as a participant in a corresponding program chatting room based on a chatting room creation method and the number of users.

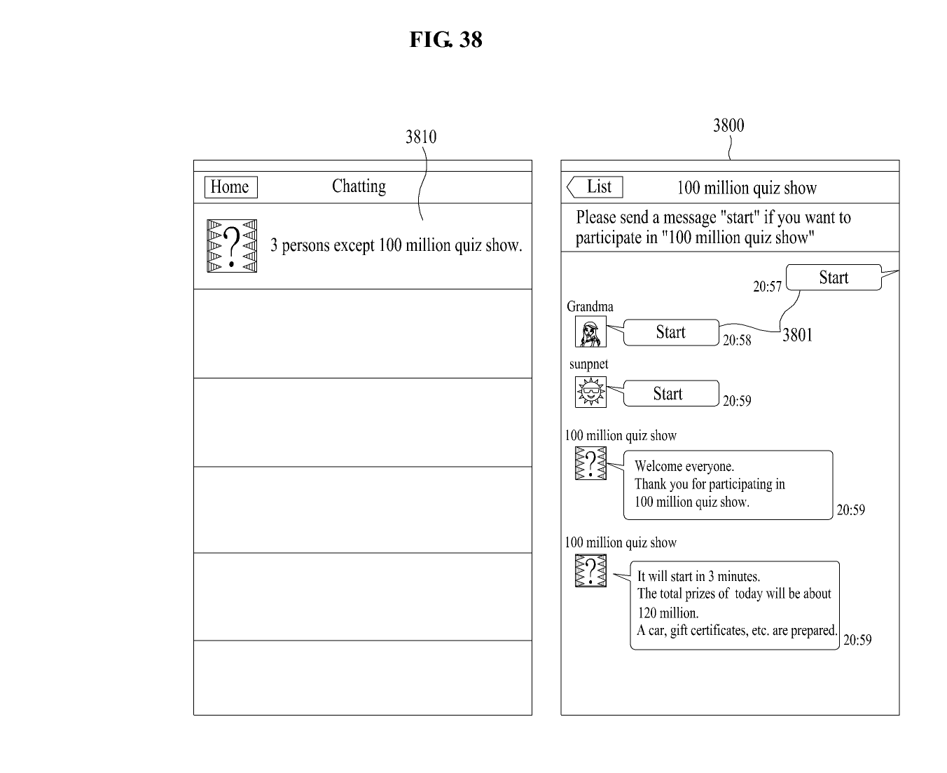

Referring to FIG. 38, in a predetermined character string input standby method, even though the program enabler service system does not send a separate message, a user may directly execute a corresponding chatting room 3800 using a program ID and may input a “character string” 3801 indicating a program participation intent. In this instance, the “character string” 3801 indicating the program participation intent is notified to all the users viewing a program. For example, “start” and “participate” may be used as a predetermined character string indicating the program participation intent. That is, a mobile IM enabler of the program enabler service system may determine whether a character string input from a user through a chatting room of a program ID matches the predetermined character string indicating a broadcast program participation intent and when they match, may set the user as a buddy of the program ID and allow the user to participate in the broadcast program through a corresponding chatting room. In this instance, when setting the user as the buddy of the program ID using the character string matching method, a buddy relationship with the program ID may be maintained during an air time of the broadcast program and a buddy setting with the user may be automatically canceled when the broadcast program is terminated. Further, in the case of a group participation using the character string matching method, when an existing group chatting room for the broadcast program is present in a chatting list 3810, the participation intent for a current episode of the corresponding broadcast program may be transferred by additionally inputting a separate message through the group chatting room present in the chatting list 3810.

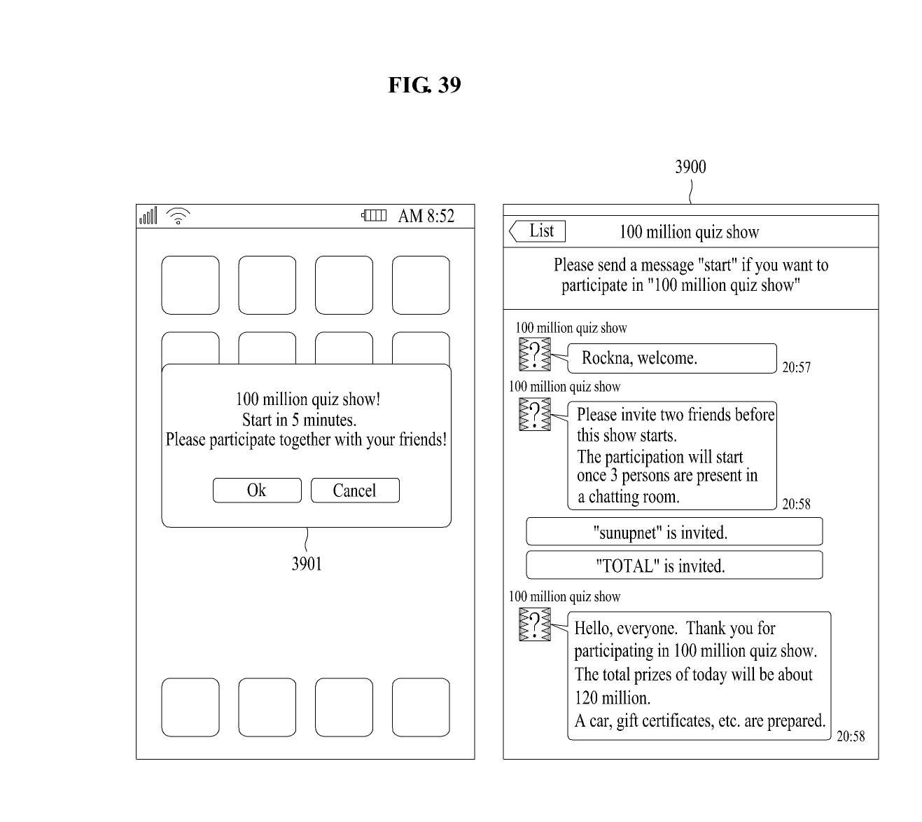

As another example, a buddy list target push method triggers a participation by sending a program start message to users having expressed a program participation intent in advance through making a friend with the program ID using the program enabler service system. Referring to FIG. 39, a program start message 3901 is pushed to all the users set as buddies and thus, a user may participate in a corresponding program by executing a chatting room 3900 at any time. That is, to trigger a participation in a broadcast program through a chatting room of the program ID, the mobile IM enabler of the program enabler service system may transfer a participation request message to users having set a buddy relationship in advance with the program ID using a message push method. Also, in the case of a group participation using the message push method, the program enabler service system may trigger a group participation in the corresponding broadcast program by providing the message 3901 indicating that “group participation” is available before a broadcast starts.

In a situation of triggering the group participation in the broadcast program, the program enabler service system may determine whether a user that is to participate in a group chatting room has set a buddy relationship with the program ID and may send a buddy recommend message to a user having not set a buddy relationship with the program ID, thereby inducing the user to set the buddy relationship with the program ID.

Also, in the case of a group participation in the broadcast program, the program enabler service system determines a question response order determined within the program chatting room in providing an individual question through the process (S2510) of FIG. 25. In this instance, when giving a question, the program enabler service system may provide a function of determining a question response order, that is, a participation order with respect to group chatting participants on the mobile IM. That is, the program enabler service system supports a function capable of determining a participation order by providing a message or a separate UI with respect to a question for which users participating in a group need to sequentially input answers.

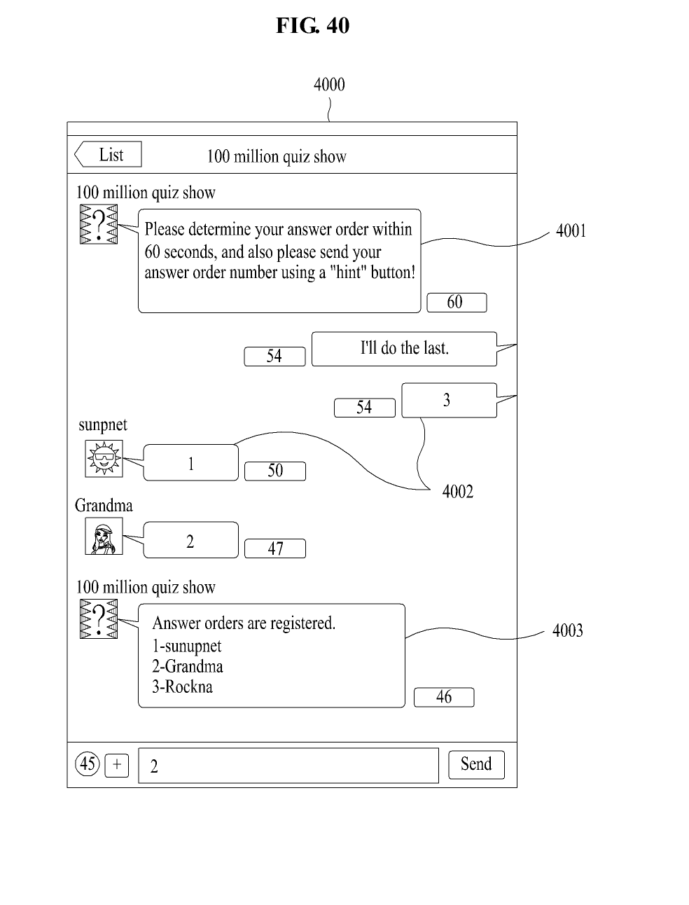

As an example, the program enabler service system may determine a response order for each user through a character string input. Referring to FIG. 40, when users “sunupnet”, “grandma”, and “Rockna” participate in a broadcast as a group, the program enabler service system may provide a guide message (for example, “Please decide your answer order in 60 seconds. Please send your response order number to this question using a “hint” button or a “#” button.) 4001 for inducing a user to determine a response order within a predetermined period of time through a screen 4000 of a corresponding group chatting room and may directly receive a participation order 4002 through a number input from each user participating in the program chatting room. In this instance, the program enabler service system may identify a character string corresponding to a response order by receiving a number through a predetermined button (a “hint” button or a “#” button). Accordingly, the program enabler service system may register a question response order for each user within the same group and may provide a registration result message 4003 indicating whether the question response order is registered and the question response order for each user through the screen 4000 of the group chatting room.

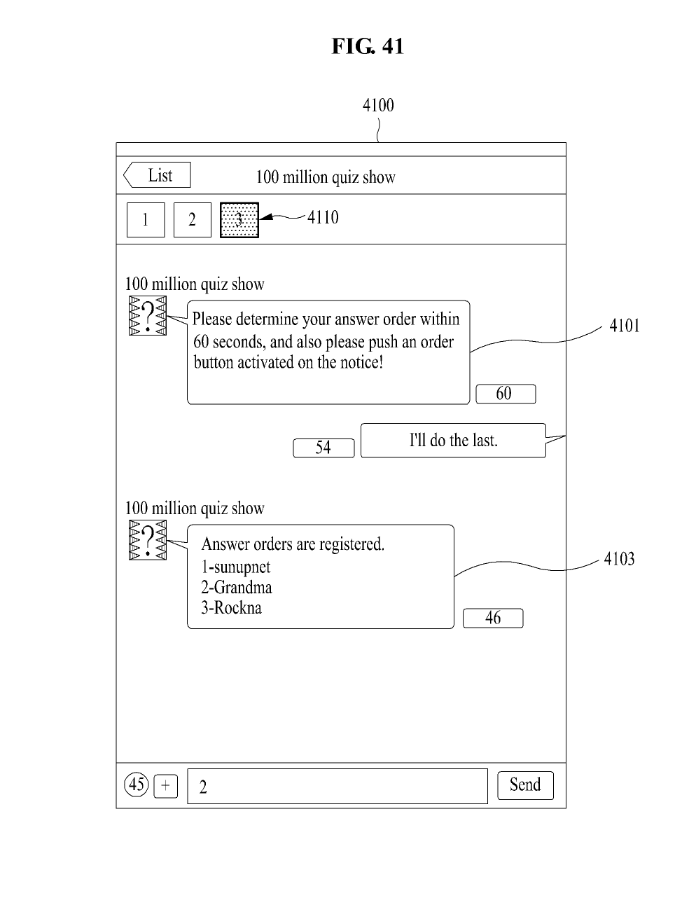

As another example, the program enabler service system may determine a response order for each user using a number button. That is, referring to FIG. 41, the program enabler service system may provide a separate UI 4110 on a screen of a program chatting room in order to receive a participation order for each user. Referring to FIG. 41, when users “sunupnet”, “grandma”, and “Rockna” participate in a broadcast as a group, the program enabler service system may provide a guide message 4101 for inducing a user to determine a response order within a predetermined period of time through a screen 4100 of the corresponding group chatting room and at the same time, may activate and thereby display number buttons 4110 at predetermined locations of the group chatting room. In this instance, the number of number buttons 4110 may be created to correspond to the number of users participating in the same group chatting room. That is, as illustrated in FIG. 41, three number buttons (a number “1” button, a number “2” button, and a number “3” button) may be activated on the screen 4100 of the group chatting room in which three users are participating. Accordingly, the program enabler service system may receive a participation order from each user participating in the program chatting room through the number button 4110. When a single number is selected on the screen 4100 of the group chatting room, the remaining number buttons are switched to be in an inactive state. For example, when the user “Rockna” selects the number “3” button among the number buttons 4110 on the screen 4100 of the group chatting room, the number “1” button and the number “2” button are switched to be in an inactive state on a chatting room screen of the user “Rockna”. In this example, the number “1” button and the number “2” button may be maintained to be in an active state on chatting room screens of the remaining users “sunupnet” and “grandma” and the number “3” button is switched to be in a selection disenable state not to allow a duplicate selection of the number “3” button. Accordingly, the program enabler service system may identify a response order for each user by receiving a number through the number button 4110 for inputting a participation order. The program enabler service system may register a question response order for each user within the same group and then may provide a registration result message 4103 indicating whether the question response order is registered and the question response order for each user through the screen 4100 of the group chatting room.

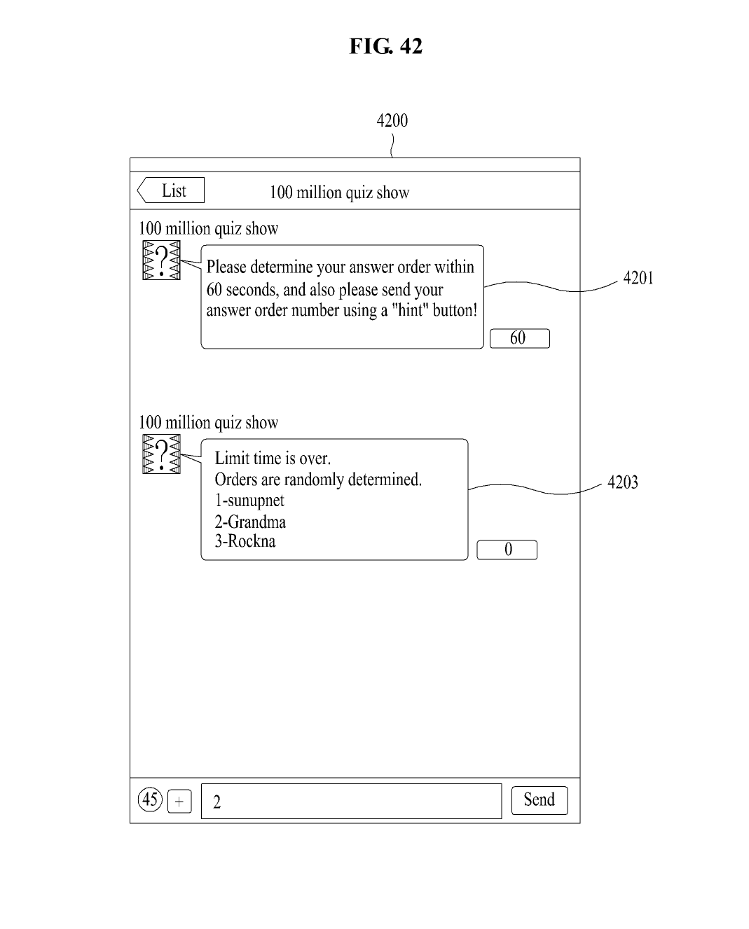

As still another example, the program enabler service system may randomly and automatically determine a question response order between users in a program chatting room. For example, referring to FIG. 42, when users “sunupnet”, “grandma”, and “Rockna” participate in a broadcast as a group, the program enabler service system may provide a guide message 4201 for inducing a user to determine a response order within a predetermined period of time through a screen 4200 of a corresponding group chatting room. When a limited time (for example, 60 seconds) in which a user is capable of inputting a participation order exceeds, the program enabler service system may randomly determine a question response order for each user within the program chatting room and register the randomly question response order. In this instance, the program enabler service system may provide a result message 4203 about the randomly determined question response order for each user through the screen 4200 of the group chatting room.

Accordingly, when all the user responses to a participation order are received through a character string input or a number button, the program enabler service system may determine a question response order for each user based on the result input from the users. When a limited time exceeds, the program enabler service system may also randomly determine a question response order for each user.

In the case of a participation of a group unit, the program enabler service system may receive a user response in order defined in the program chatting room through the process (S2517) of FIG. 25. When a final response is input from a user corresponding to a last order, the program enabler service system may record user responses based on a group unit by recording a correct answer or an incorrect answer for each user and group chatting room information.

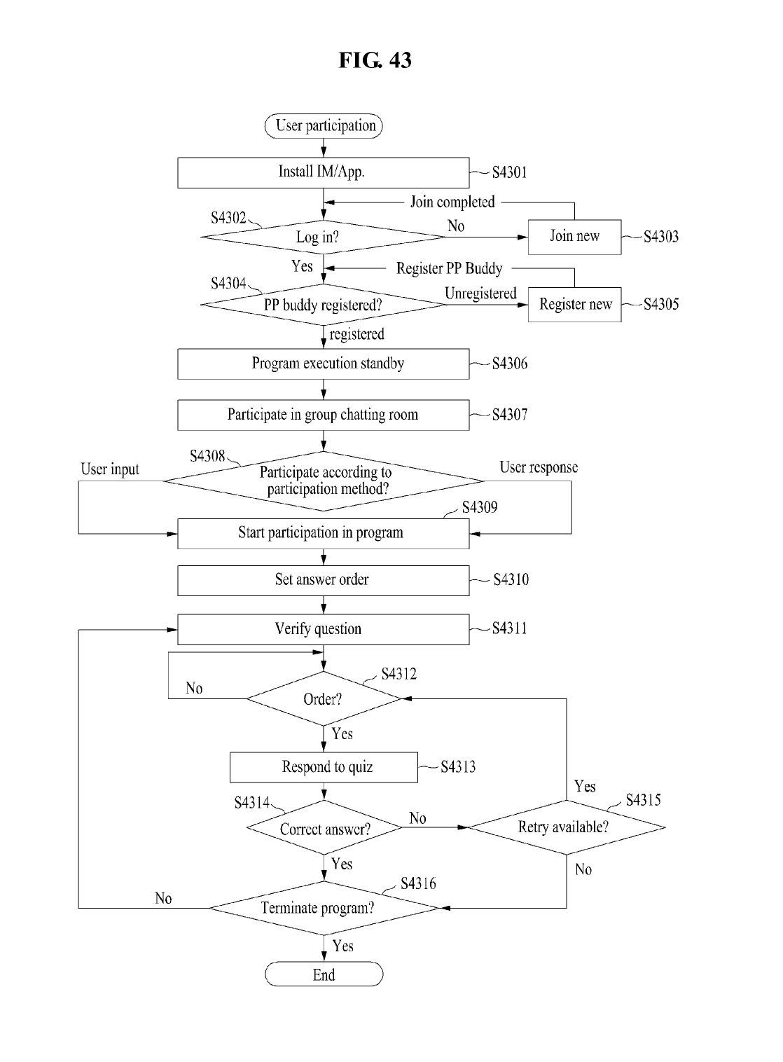

FIG. 43 is a flowchart illustrating a method of allowing a user to participate in a program through a group chatting room according to an embodiment of the present invention.

Referring to FIG. 43, a user terminal installs a mobile IM application in response to a request of a user (S4301). In this instance, the mobile IM application, as a messenger program supported in a mobile environment such as Kakao Talk, Line, Tick Talk, and NATE ON, may indicate any type of messengers generally used. To participate in an interactive service program, the user needs to register a buddy ID of a corresponding manager to a buddy list through the mobile IM application installed in the terminal (S4302 through S4305).

The user terminal maintains a program execution standby state when an actual broadcast program is not initiated yet (S4306). Here, the program execution standby state may indicate a situation up to a time designated by the program manager (for example, 5 minutes before the program starts).

When the actual broadcast program starts, the user terminal may execute a chatting of the corresponding program using a program participation method designated by the program manager for triggering the user to participate in a program through the mobile IM application (S4307 through S4309). In the present embodiment, the chatting room of the corresponding program may be executed using a predetermined character string input standby method (FIG. 38) and a buddy list target push method (FIG. 39). That is, in the case of using the predetermined character string input standby method, the user may participate in the broadcast program by directly executing a program chatting room using a program ID and by inputting a predetermined character string in the program chatting room. Also, in the case of using the buddy list target push method, the user may participate in the broadcast program by executing a program chatting room at a time when a participation request message is received from the program enabler service system in a state in which the user has registered the program ID to a buddy list of the user in advance. Also, when an actual broadcast program gives a question requiring a group participation or when a user participates as a group together with a plurality of friends irrespective of a question type, the user terminal may participate in the group chatting room of the broadcast program. Accordingly, in the case of the group participation, the user terminal may set a question response order that is an answer order to a given question based on a user designation through a function of determining a participation order (S4310).

The user terminal may receive a question given during a program execution from the program enabler service system, and may display the received question through a program chatting room of the mobile IM (S4311). Accordingly, the user may verify the question through a TV screen on which the corresponding program is on air and a conversation window of the mobile IM. In this instance, the user terminal may verify an order of the user based on the question response order for each user within the program chatting room (S4312). The program enabler service system may inform a corresponding user of a user order for inputting a response through a message based on the question response order defined within the program chatting room. Also, when the given question is a hint giving question, the user terminal may receive a hint giving query from the program enabler service system and may display the hint query through the program chatting room. Here, the user terminal may receive a response to the hint query from the user and may transfer the received response to the program enabler service system. The program enabler service system may display the hint of the question in the program chatting room to be verified by the user, based on a hint query matching result.

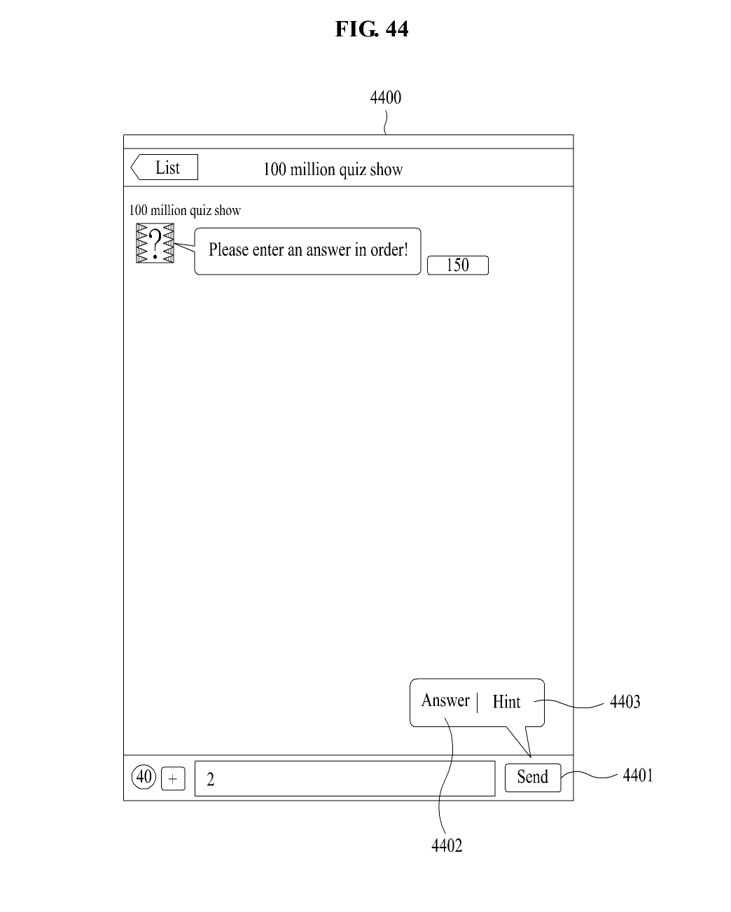

FIG. 44 illustrates a UI screen for inputting a message in a group chatting room.

In the present embodiment, a message input from a user through a chatting room of a mobile IM may be classified into a response message that is a message sent to the program enabler service system and a general message that is a message sent and received between users participating in a broadcast program. In this instance, the response message may be classified into at least one message based on a type of an interactive object included in the broadcast program. As a representative example, when a quiz including a hint giving question is given during a broadcast, the response message may be classified as a response message to a hint and a response message to the quiz that is the question.

In addition, the UI management module 1861 of the mobile IM application 1860 installed on a terminal of the user may provide a plurality of input buttons as a UI for inputting a message in the program chatting room, so that the user may classify and thereby send a message based on a message input intent. As an example, referring to FIG. 44, the UI management module 1861 may provide a send button 4401 for inputting a message when participants within the same group converse with each other, an answer button 4402 for inputting an “answer” to a question, and a hint button 4403 for inputting a “response” to a hint. In this instance, only the send button 4401 that is a basic input button of a messenger may be displayed to be in an activate state on an initial screen of the program chatting room 4400 without displaying the answer button 4402 and the hint button 4403 on the screen. Accordingly, when the user pushes long the send button 4401, the answer button 4402 and the hint button 4403 may be activated and be displayed on a screen of the program chatting room 4400. Also, the UI management module 1861 may automatically control an activation of the answer button 4402 and the hint button 4403 through interaction with the broadcast program by the program enabler service system. For example, the UI management module 1861 may activate the answer button 4402 during a predetermined period of time based on a time at which the question is given in the broadcast program and may activate the hint button 4403 based on a time at which a hint giving question is given in association with the question.

In a case in which the user is to submit a response to the question, when the user inputs a message and pushes the send button 4401, a corresponding response may not be submitted and when the user activates the answer button 4402 and pushes the answer button 4402, the response to the question may be submitted. Similarly, in the case of a hint, a response to the hint is submitted through the hint button 4403 instead of using the send button 4401. That is, when the user creates a message and then uses the send button 4401 in the program chatting room 4400, the message may be input as a general message to be sent to other users participating in the same group. When the user uses the answer button 4402, the message may be input as a response to the question. When the user uses the hint button 4403, the message may be input as a response to the hint. In this instance, the program enabler service system may receive each response through a UI classified on the terminal of the user or using a separate combination of hash character string values.

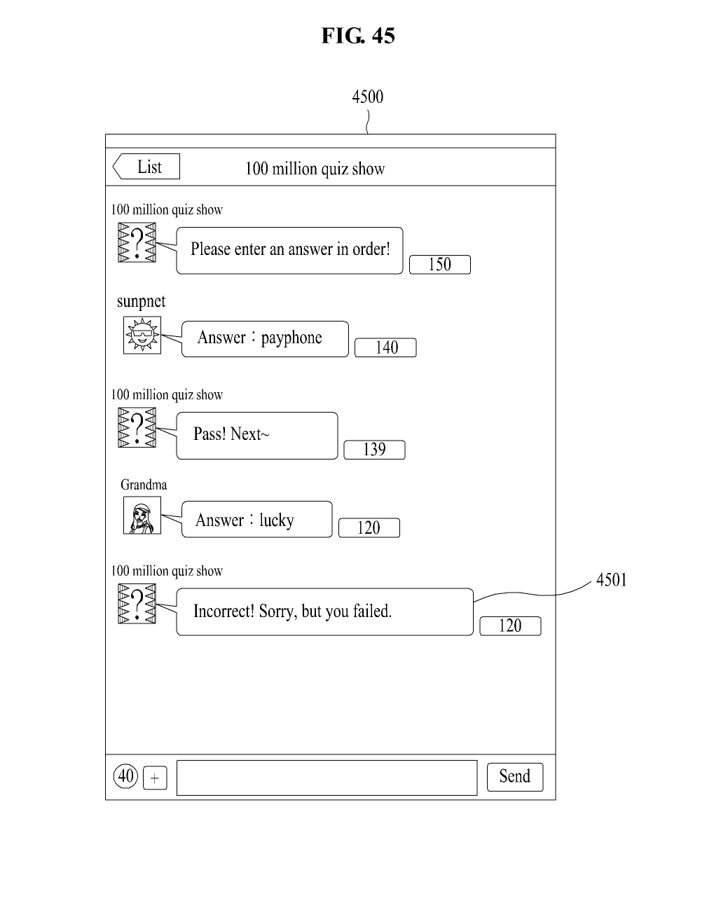

Referring again to FIG. 43, when the user inputs the response to the question, the user terminal may transfer the response to the program enabler service system and the program enabler service system may display a result of verifying whether the response is a correct answer or an incorrect answer and whether the user is allowed to make a retry, on the program chatting room to be verifiable by the user (S4313 and S4314). Also, referring to FIG. 45, the user terminal may display the retry availability (4501) provided from the program enabler service system, on a program chatting room 4500 as a message verifiable by the user (S4315). In the present embodiment, in the case of participating in a broadcast program based a group unit, when each user individually inputs a response to a question, whether the response is a correct answer may be filtered based on a designed order. When the response is input out of order, the response may be processed as an incorrect answer. Also, different processing may be performed for each user, such as limiting a retry opportunity to a user having input an incorrect answer, based on the examiner intent.

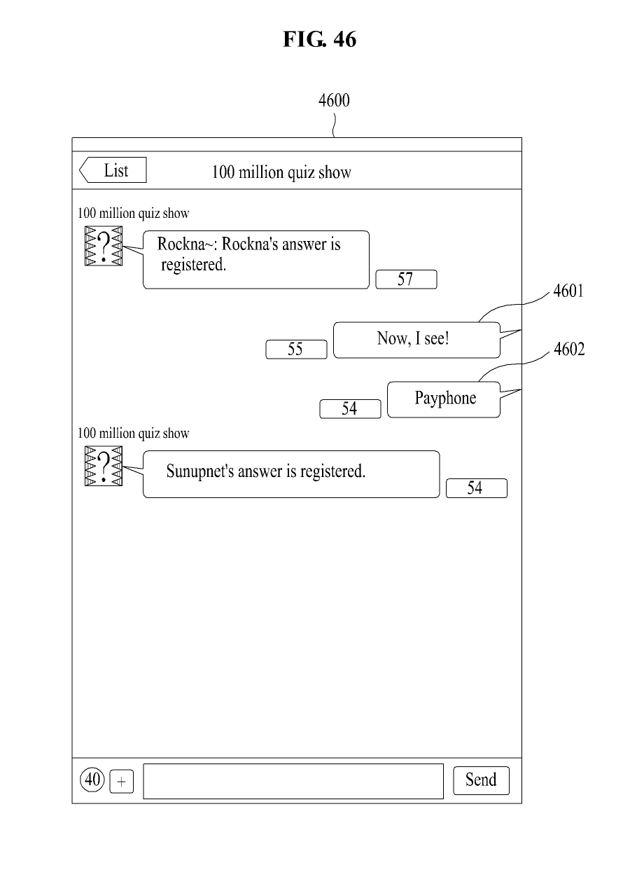

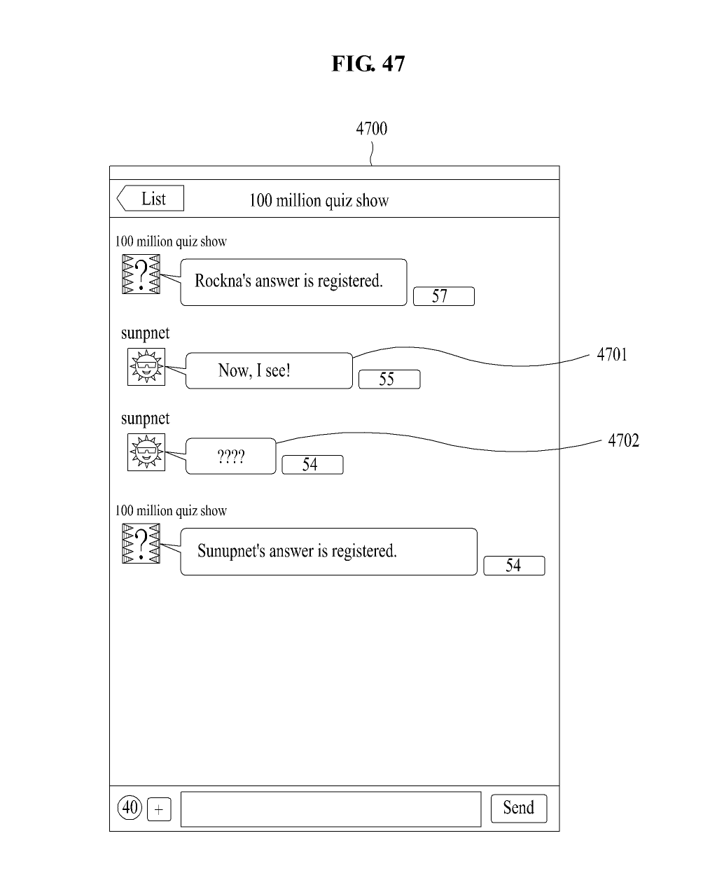

Further, in the present embodiment, when displaying messages sent and received between the program enabler service system and a user on a screen of a group chatting room, a response message created by the user may be replaced with a predetermined character string and the replaced character string may be displayed not to be exposed to other participants. As an example, a general message may be open to all the users participating in the group chatting room and a response message may be replaced with a predetermined character string and thereby displayed not to be exposed to other participants excluding a user having creating the corresponding message. In an example in which a user “Sunupnet” and a user “Rockna” are assumed to participate in a broadcast program as group buddies, FIG. 46 illustrates a conversation screen 4600 in place of the user “Sunupnet” and FIG. 47 illustrates a conversation screen 4700 in place of the user “Rockna”. In this instance, general messages 4601 and 4701 sent from the user “Sunupnet” to the user “Rockna” are exposed as are on the conversation screen 4600 of the user “Sunupnet” having created the corresponding messages and the conversation screen 4700 of “the user Rockna” having received the corresponding messages. Meanwhile when the user “Sunupnet” has created a response message to a question, actual content of a response message 4602 is exposed as is on the conversation screen 4600 of the user “Sunupnet” having created the corresponding message. In contrast, a replaced character string (for example, “????”) 4702 may be displayed instead of the response message 4602 to prevent the content of the response message 4602 not to be open to the user “Rockna”. Accordingly, in the present embodiment, a response message sent from a user with respect to a broadcast program may be verified by the user having created the response message without being exposed to other users. Also, in the present embodiment, the program enabler service system may provide a reception complete message (for example, “Sunupnet's answer is registered.” and “Rockna's answer is registered.”) about messages input from individual participants participating in a group chatting room.

Referring again to FIG. 43, the user terminal may maintain the user's participation in the program until the program is terminated (S4316). That is, even though the user executes another application after participating in the program chatting room, the program enabler service system recognizes that the user is to maintain the participation in the corresponding program unless the user selects a separate program participation end. Also, when a corresponding episode of the program is terminated after the user participates in the program chatting room, the program enabler service system may terminate an instance of a corresponding service and the user may leave the participating program chatting room. In this instance, when the user is to participate in a subsequent episode of the program in a state of maintaining a chatting room after the program is terminated, the user needs to express the intent regarding whether to participate in this episode. In this case, similarly, a participation character string input request message may be sent to the user and the user may participate in the corresponding program by inputting a character string.

The program enabler service method described above with reference to FIGS. 23 through 47 may include a reduced number of operations or additional operations. Also, at least two operations may be combined and orders or locations of operations may be changed.

As described above, according to embodiments of the present invention, there is provided a system in which an editor for producing an interactive broadcast program and an enabler capable of associating and thereby executing a broadcast program produced through the editor with existing communication channels are combined and thus, it is possible to format program information and thereby improve the production and management efficiency. Also, it is possible to easily and conveniently provide various communication functions required for the interactive broadcast program.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method of providing a user interface for an interactive broadcast program, the method comprising:
executing a chatting room that allows a participation in a broadcast program using a program identifier (ID) that is a buddy ID created on a mobile instant messenger (IM) with respect to the broadcast program; and
displaying a message sent to or received from a user in association with the broadcast program through the chatting room,
wherein the displaying of the message comprises providing a plurality of input buttons of identifying an intent for participation in the broadcast program and thereby enabling a message input, as a user interface for inputting a message of the user, on a screen of the chatting room.

2. The method of claim 1, wherein the plurality of input buttons comprises a first input button for inputting a response to an interactive object that allows a participation of the user with respect to the broadcast program and a second input button for inputting a response to additional information associated with the interactive object.

3. The method of claim 2, wherein the interactive object is a target indicating one of a question, a survey, a vote, and an application given in the broadcast program, and the additional information is a hint about the interactive object.

4. The method of claim 1, wherein when a question that allows a participation of the user is given in the broadcast program and the question comprises a hint, the plurality of input buttons comprises a first input button for inputting a response to the question and a second input button for inputting a response to the hint.

5. The method of claim 4, wherein the response to the question and the response to the hint are stored and thereby managed using separate flags.

6. The method of claim 4, wherein the displaying of the message comprises displaying a response input result through the first input button or the second input button on the screen of the chatting room, and verifying whether the response input result is a response input to the question or a response input to the hint and displaying the response input result.

7. The method of claim 1, wherein whether to activate the plurality of input buttons is determined through interaction with the broadcast program.

8. The method of claim 1, wherein the executing of the chatting room comprises executing a group chatting room that allows a participation of a group unit with respect to the broadcast program, and
the plurality of input buttons comprises a first input button for inputting a message to be sent to another user within a group and a second input button for inputting a response to an interactive object that allows a participation of the user,
wherein the displaying of the message comprises displaying a predetermined character string on a screen of the group chatting room instead of displaying the response to the interactive object.

9. (canceled)

10. The method of claim 1, wherein the displaying of the message comprises applying a color index according to a type of the message on a screen of the chatting room.

11. The method of claim 10, wherein the color index designates a different color for each message classified based on a progress time of the broadcast program.

12. The method of claim 10, wherein the color index designates a different color for each message classified based on an event associated with the broadcast program.

13. The method of claim 10, wherein when a question that allows a participation of the user is given in the broadcast program and the question comprises hint information, the color index identifies a message associated with the question and a message associated with the hint information using a color.

14. The method of claim 1, wherein the displaying of the message comprises providing the user with time information associated with an interactive object based on a progress time of the broadcast program on a screen of the chatting room, with respect to the interactive object that allows a participation of the user in the broadcast program.

15. The method of claim 14, wherein the time information is a remaining time in which the user is capable of inputting a message in the chatting room as a response to the interactive object, and
the remaining time is indicated at each of a message received time and a message sent time for each of a received message and a sent message in the chatting room.

16. The method of claim 14, wherein the time information is a remaining time in which the user is capable of inputting a message in the chatting room as a response to the interactive object, and
the remaining time is indicated in a form of a progress bar in the chatting room.

17. The method of claim 14, wherein the time information is a remaining time in which the user is capable of inputting a message in the chatting room as a response to the interactive object, and
a timer for counting the remaining time based on a unit time is displayed in the chatting room.

18. The method of claim 14, wherein when a question that allows a participation of the user is given in the broadcast program and the question comprises a query for giving a hint, a remaining time in which a response input to the query is allowed and a remaining time in which a response input to the question is allowed are displayed in the chatting room.

19. The method of claim 14, wherein the displaying of the message comprises providing the user with at least one set of statistical information associated with the broadcast program based on a progress time of the broadcast program, on the screen of the chatting room.

20. The method of claim 1, wherein the executing of the chatting room comprises:
executing a group chatting room that allows a participation of a least two users based on a group unit with respect to the broadcast program; and
setting a response order of the user in the group chatting room with respect to an interactive object that allows a participation of the user in the broadcast program.

21-25. (canceled)

26. A system for providing a user interface for an interactive broadcast program, the system comprising:
a processor; and
a computer storage medium configured to store a mobile instant messenger (IM) application executed by the processor,
wherein the mobile IM application comprises a UI management module configured to execute a chatting room that allows a participation in a broadcast program using a program identifier (ID) that is a buddy ID created on a mobile IM with respect to the broadcast program, to display a message sent to or received from a user in association with the broadcast program through the chatting room, and to provide a plurality of input buttons of classifying an intent for participation in the broadcast program and thereby enabling a message input, as a user interface for inputting a message of the user, on a screen of the chatting room.

27-29. (canceled)
